(19) United States
(12) Patent Application Publication
(10) Pub. No.: US 2006/0002824 A1
(43) Pub. Date: Jan. 5, 2006

(54) Dispensing systems, software, and related methods

(75) Inventors: Jim Yuchen Chang, San Diego, CA (US); Kenneth J. Micklash II, Royal Oak, MI (US); Robert Charles Downs, La Jolla, CA (US); James Kevin Mainquist, San Diego, CA (US); Christopher M. Shaw, San Diego, CA (US)

Correspondence Address: QUINE INTELLECTUAL PROPERTY LAW GROUP, P.C., P O BOX 458, ALAMEDA, CA, 94501, US

(73) Assignee: IRM, LLC, Hamilton (BM)

(21) Appl. No.: 11/146,916

(22) Filed: Jun. 6, 2005

Related U.S. Application Data
(60) Provisional application No. 60/577,849, filed on Jun. 7, 2004.

(51) Int. Cl. B01L 3/02

(52) U.S. Cl. 422/100

(57) ABSTRACT

The present invention provides dispensing systems that include peristaltic pumps and other pressure sources for the efficient delivery of accurate volumes of fluidic materials into the wells of multi-well containers or onto substrate surfaces. These systems are typically configured to dispense volumes of fluid having substantially uniform densities. Related computer program products and methods of dispensing fluidic materials are also provided.

### CROSS-REFERENCES TO RELATED APPLICATIONS

This application claims the benefit of U.S. Provisional Application No. 60/577,849, filed Jun. 7, 2004, the disclosure of which is incorporated by reference in its entirety for all purposes.

### FIELD OF THE INVENTION

The present invention relates generally to material dispensing. In addition to dispensing systems, related software and methods for efficiently and accurately dispensing selected quantities of materials are provided.

### BACKGROUND OF THE INVENTION

High-throughput screening devices and systems are important analytical tools in the process of discovering and developing new drugs. Drug discovery procedures typically involve synthesis and screening of candidate drug compounds against selected targets. Candidate drug compounds are molecules with the potential to modulate diseases by affecting given targets. Targets are typically biological molecules, including proteins such as enzymes and receptors, or nucleic acids, which are thought to play roles in the onset or progression of particular diseases. A target is typically identified based on its anticipated role in the progression or prevention of a disease. Recent developments in molecular biology and genomics have led to a dramatic increase in the number of targets available for drug discovery research.

Once a target is identified, a library of compounds is typically selected to screen against the target. Enormous compound libraries have been compiled from natural sources and via various synthetic routes, including multi-step solution- or solid-phase combinatorial synthesis schemes. In fact, many pharmaceutical companies and other institutions have access to libraries that include hundreds of thousands of compounds. Following the selection of a target and compound library, the compounds are screened to determine if they have any affect on the target. Compounds that affect the target are denominated as hits. A basic premise for screening larger numbers of compounds against a particular target is the increased statistical probability of identifying a hit.

Before screening compounds against a target, the assay is developed. The assay development process includes selecting and optimizing an assay that will measure the performance of a compound against the selected target. Assays are generally classified as either biochemical or cellular. Biochemical assays are typically performed with purified molecular targets, whereas cellular assays are performed with living cells. While cellular assays often provide more biologically relevant information than biochemical assays, they are typically more complex and time-consuming to perform than biochemical counterparts.

In performing biochemical and cellular assays, samples are routinely characterized by examining properties, such as fluorescence, luminescence, and absorption. In a fluorescence study, for example, selected tissues, specific binding partners, chromosomes, or other structures are treated with a fluorescent probe or dye. The sample is then irradiated with light of a wavelength that causes the fluorescent material to emit light at a longer wavelength, thus allowing the treated structures to be identified and to at least some extent quantified. In a luminescence analysis, the sample is not irradiated in order to initiate light emission by the material. Instead, one or more reagents are typically added to the sample in order to initiate the luminescence phenomena. In an absorption analysis, a dye-containing sample is typically irradiated by an electromagnetic radiation source of a selected wavelength. The amount of light transmitted through the sample is generally measured relative to the amount of light transmitted through a reference sample without dye. Analytical devices and systems utilized to determine the fluorescence of a sample typically include at least one electromagnetic radiation source capable of emitting radiation at one or more excitation wavelengths and a detector for monitoring the fluorescence emissions. In many cases, these devices and systems can also be adapted for use in both luminescence and absorption analyses.

To produce or accommodate the large number of compounds and targets, multiple synthesis reactions or screens are often performed in parallel in the wells of standard multi-well containers (e.g., microtiter plates, reaction blocks, etc.) of selected well-densities and even on the surfaces of various supports, such as membranes or treated glass. Parallel syntheses or screens typically include dispensing multiple reaction components (e.g., beads or other solid supports, reactants, buffers, etc.) or samples into the wells of multi-well containers or onto the surfaces of supports. Many conventional systems include pipetting devices in which fluids are aspirated from sources through, e.g., pipette tips using syringe pumps before being dispensed from the same pipette tips. While suitable for some applications, the cost of replacing pipette tips adds to the overall cost of performing compound synthesis or screening. The cost of replacing these consumables can be substantial, given the large numbers of synthesis reactions or screens that are typically performed to ultimately identify hits. In addition, pipette tip openings can become obstructed by beads, cells, or precipitate or other debris, which typically necessitates halting the synthesis or screen in order to clear the obstruction or to replace the tip. Moreover, certain dispensing systems include valves that contact dispensed fluid, such as suspensions of beads for combinatorial synthesis protocols. The valves used in these configurations often also readily clog and beads can destroy their sealing ability. Another exemplary shortcoming of many of these dispensing systems is that they commonly dispense volumes that lack uniform densities. The limited robustness of these pre-existing dispensing systems can severely limit the throughput of synthesis or screening procedures, which have become increasingly automated.

### SUMMARY OF THE INVENTION

The present invention relates to rapid and reliable material dispensing. In some embodiments, for example, dispensing systems that include peristaltic pumps and other pressure sources are provided for the efficient delivery of accurate volumes of fluidic materials, such as bead suspensions or other fluids into the wells of multi-well plates and reaction blocks or into other types of fluid containers or onto substrate surfaces. Typically, the systems described herein are configured to dispense volumes of fluid having substantially uniform densities. Density variations among volumes of dispensed fluids can lead to biased assay results and to inconsistent synthetic yields, among many other possible detrimental effects depending upon the particular dispensing application. In certain embodiments, the dispensing systems described herein include fluid junction blocks for introducing gases into system conduits, e.g., to purge fluids from the conduits, to create gaps between system and source fluids disposed in the conduits, or the like. To illustrate, gaseous gaps (e.g., air gaps, etc.) can be used to separate system and source fluids from one another to prevent system fluids from diluting the source fluids. In addition to system software, methods of dispensing fluidic materials are also provided.

In one aspect, the invention provides a dispensing system that includes at least one peristaltic pump configured to convey at least a first fluidic material into or through at least a portion of at least one conduit when the conduit is operably connected to the peristaltic pump and is in fluid communication with at least a first fluidic material source. In some embodiments, the peristaltic pump comprises a multi-channel peristaltic pump. The dispensing system also includes at least one pressure source other than the peristaltic pump. The pressure source is configured to apply pressure in the conduit when the pressure source is operably connected to the conduit such that selected aliquots of the first fluidic material are dispensed from at least one opening in the conduit when the first fluidic material is present in the conduit. In some embodiments, the pressure source includes one or more pumps.

In addition, the dispensing system also includes at least one controller operably connected to the pressure source. The controller is configured to control operation of the pressure source to effect dispensing of the first fluidic material from the opening in the conduit when the conduit is in fluid communication with the first fluidic material source. In some embodiments, the controller is also operably connected to the peristaltic pump. In these embodiments, the controller is optionally configured to effect rotation of a roller support of the peristaltic pump in at least one rotational increment that substantially corresponds to an integral multiple of an angular distance disposed between adjacent rollers supported by the roller support such that quantities of the first fluidic material that correspond to the rotational increment are conveyed into or through the conduit when the conduit is operably connected to the peristaltic pump and is in fluid communication with the first fluidic material source. The phrase “integral multiple of an angular distance disposed between adjacent rollers” refers to the product of the angular distance disposed between adjacent rollers supported by a roller support of a peristaltic pump by an integer, that is, any of the natural numbers, the negatives of these numbers, or zero. Typically, the dispensing system includes a mounting component to which the peristaltic pump, the pressure source, the controller, and/or another system component is attached.

In some embodiments, the dispensing system includes at least one pinch valve configured to regulate conveyance of fluidic materials through the conduit when the conduit is operably connected to the pinch valve. Typically, at least one air table is operably connected to the pinch valve. The air table is configured to effect operation of the pinch valve. In these embodiments, the controller is optionally also operably connected to the air table. The controller is configured to control operation of the air table to effect regulation of fluidic material conveyance through the conduit when the conduit is operably connected to the pinch valve.

The dispensing system generally includes the conduit. Typically, at least one dispensing tip or nozzle fluidly communicates with the conduit and comprises an opening to the conduit. In some embodiments, for example, at least one waste collection component is configured to selectively communicate with the opening in the conduit such that waste fluids can be dispensed into the waste collection component for disposal. To further illustrate, a fluid reservoir is optionally in fluid communication with the conduit.

In certain embodiments, a substantial portion of the conduit is disposed other than parallel to a Z-axis of the dispensing system. To illustrate, at least a segment of the conduit disposed between the opening and the peristaltic pump comprises a conduit coil in some of these embodiments. Generally, at least one coil in the conduit coil is disposed other than parallel to a Z-axis of the dispensing system in these embodiments. This conduit orientation prevents beads or other materials in fluids from settling toward an opening in the conduit such that volumes having uniform densities are dispensed from the conduit. Optionally, at least a segment of the conduit that comprises the opening is disposed at an angle of between about 0° and about 90° relative to a Z-axis of the dispensing system. For example, fluids dispensed into the wells of multi-well containers from conduits having this configuration contact the sides of the wells before other parts of the wells. This minimizes the disruption of other materials disposed in the wells during fluid dispensing. In addition, this configuration also minimizes the foaming of reagents or media (e.g., Bright-Glo™ reagent, fetal bovine sera (FBS) media, etc.) in the wells during dispensing by dissipating the kinetic energy of the fluid on the walls of the wells. Foam is typically undesirable, because it can interfere with optical plate readers or the like.

To further illustrate, the dispensing system comprises multiple conduits in certain embodiments. In some of these embodiments, openings in at least two of the conduits are spaced at a distance from one another to simultaneously fluidly communicate with different wells disposed in at least one multi-well container. Optionally, the opening in the conduit comprises at least one manifold that is configured to fluidly communicate with multiple fluidic material sites, e.g., multiple wells disposed in a multi-well plate, a reaction block, etc.

In some embodiments, the peristaltic pump is operably connected to at least a first conduit and the pressure source is operably connected to at least a second conduit, which first and second conduits fluidly communicate with one another. In these embodiments, at least one three-way valve is optionally operably connected to the first conduit, which three-way valve is structured to selectively vent the first conduit.

In certain embodiments, the pressure source is in fluid communication with the conduit. To illustrate, the pressure source optionally comprises a pressurized gas source and/or a pressurized second fluidic material source. Optionally, at least one filter (e.g., 0.45 μm or less) is operably connected to the conduit. In some embodiments, the second fluidic material source comprises at least one buffer, e.g., used as a system fluid. The pressure source is typically operably connected to the conduit via at least one solenoid or other type of valve that regulates pressure applied by the pressure source. The controller is optionally operably connected to the valve. In these embodiments, the controller is generally configured to control operation of the valve to effect regulation of the applied pressure.

A port is disposed through at least one wall of the conduit and communicates with at least one cavity disposed through the conduit in certain embodiments. For example, the port is typically disposed between the peristaltic pump and the pressure source in the conduit. The port typically comprises a length of about 5 mm or less. Moreover, a region of the conduit that comprises the port comprises a fluid junction block in some of these embodiments. To illustrate, at least one gas valve is optionally operably connected to the port. The gas valve regulates gas flow into the conduit through the port when the gas valve is operably connected to at least one pressurized gas source. In some embodiments, for example, the gas valve includes a plunger comprising a compliant seal material that forms a face seal with the port when the plunger pushes the compliant seal material into contact with the port. Typically, the gas valve is operably connected to the pressurized gas source that flows gas (e.g., air, nitrogen, helium, argon, etc.) to the gas valve at a pressure of between about zero pounds per square inch and about 10 pounds per square inch. In certain embodiments, at least one air table is operably connected to the gas valve. The air table is configured to effect operation of the gas valve. In some of these embodiments, the controller is operably connected to the air table and is configured to control operation of the air table to effect regulation of gas flow into the conduit through the port when the gas valve is operably connected to the pressurized gas source.

In some embodiments, the dispensing system includes the first fluidic material source. To illustrate, the first fluidic source optionally comprises one or more of, e.g., beads, cells, enzymes, reagents, or the like. In certain of these embodiments, at least one fluid agitation mechanism is operably connected to the first fluidic material source.

The dispensing system optionally includes at least one positioning component operably connected to the controller. The positioning component is configured to moveably position one or more conduits and/or one or more fluidic material sites relative to one another. To illustrate, the positioning component optionally comprises at least one X/Y-axis linear motion component operably connected to at least one control drive that controls movement of the X/Y-axis linear motion component along an X-axis and a Y-axis of the dispensing system. In these embodiments, the controller is typically operably connected to the pressure source and is configured to simultaneously effect application of pressure in the conduits from the pressure source and moveably position the conduits and/or the fluidic material sites relative to one another such that volumes of fluid are conveyed from the conduits synchronous with the relative movement of the conduits and/or the fluidic material sites. In certain embodiments, the positioning component comprises at least one Z-axis linear motion component comprising at least one conduit support head that is configured to support at least segments of the conduits and that moves along a Z-axis of the dispensing system. The positioning component optionally comprises at least one object holder that is structured to support at least one fluidic material site. In some embodiments, at least one cleaning component is operably connected to the controller. The cleaning component is configured to clean at least segments of the conduits when the conduits are operably connected to the positioning component and the positioning component moves the conduit segments at least proximal to the cleaning component. For example, the cleaning component optionally comprises at least one vacuum chamber comprising at least one orifice into or proximal to which the positioning component moves the conduit segments such that an applied vacuum removes adherent material from at least external surfaces of the conduit segments.

In some embodiments, the dispensing system includes at least one detector configured to detect detectable signals produced in fluidic materials. Typically, the controller is operably connected to the detector and is configured to control the detector to effect detection of the detectable signals.

In another aspect, the invention provides a computer program product comprising a computer readable medium having one or more logic instructions for: operating at least one peristaltic pump to effect conveyance of at least a first fluidic material into at least one conduit through at least a first opening of the conduit, and operating at least one pressure source other than the peristaltic pump to effect application of pressure on the first fluidic material in the conduit such that at least one aliquot of the first fluidic material is dispensed from at least a second opening of the conduit. In certain embodiments, the computer program product includes at least one logic instruction for receiving one or more input parameters selected from the group consisting of: (i) a quantity of the first fluidic material to be conveyed to a fluidic material site; (ii) an initial density of the first fluidic material; (iii) a quantity of a second fluidic material to be added to the first fluidic material to modify a density of the first fluidic material; (iv) a quantity of gas to convey into the conduit to separate the first fluidic material from a second fluidic material; and (v) a fluidic material site format. In some embodiments, the computer program product includes at least one logic instruction for: operating at least one valve operably connected to the conduit to effect regulation of material conveyance into and/or out of the conduit. In certain embodiments, the computer program product includes at least one logic instruction for: operating at least one X/Y-axis linear motion component and/or at least one Z-axis motion component to effect movement of one or more other components attached to or positioned on the X/Y-axis linear motion component or the Z-axis motion component.

In another aspect, the invention relates to a method of dispensing a fluidic material. The method includes (a) conveying at least a first fluidic material (e.g., beads, cells, enzymes, reagents, and/or the like) into at least one conduit through at least a first opening of the conduit using at least one peristaltic pump. Typically, at least a segment of the conduit comprises a non-vertical flow path to prevent one or more components of the first fluidic material from settling proximal to the second opening. The method also includes (b) applying pressure on the first fluidic material in the conduit using at least one pressure source other than the peristaltic pump such that at least one aliquot of the first fluidic material is dispensed from at least a second opening of the conduit. In certain embodiments, the method includes dispensing the aliquot of the first fluidic material unto a wall of a container (e.g., a well of a multi-well container, etc.), e.g., to minimize the disruption of materials disposed on the bottom of the container, to prevent reagents or media from foaming, etc. Optionally, the method includes conveying a gas into the conduit to purge fluidic materials from at least one segment of the conduit prior to (a). In some embodiments, the method includes dispensing multiple aliquots of the first fluidic material during (b). Optionally, the method includes performing at least one synthesis reaction or assay using one or more components in the aliquot of the first fluidic material after (b). In certain embodiments, the method includes restricting fluidic material conveyance in the conduit directed towards the peristaltic pump during (b). In some embodiments, the method includes performing (a) and (b) substantially simultaneously with one another. Optionally, the method includes repeating (a) and (b). In some embodiments, the method includes moveably positioning at least one fluidic material site relative to the second opening. In certain embodiments, the method includes detecting one or more detectable signals produced in the conduit and/or in the aliquot of the first fluidic material.

In some embodiments, the method includes conveying at least a second fluidic material (e.g., a buffer, etc.) through one or more segments of the conduit using the pressure source such that the second fluidic material expels the aliquot of the first fluidic material from the second opening of the conduit during (b). In certain of these embodiments, the method includes diluting the first fluidic material with the second fluidic material prior to or substantially simultaneously with (b). In some of these embodiments, the method includes conveying a gas into the conduit through a port to form a gap between the first and second fluidic materials to prevent the first and second fluidic materials from mixing with one another.

In another aspect, the invention provides a method of dispensing aliquots of fluidic materials having substantially uniform densities. The method includes conveying selected aliquots of at least one fluidic material from at least one dispensing tip that fluidly communicates with at least one conduit through which the fluidic material is conveyed. The conduit comprises a non-vertical flow path such that components in the fluidic material are prevented from settling proximal to the dispensing tip prior to being dispensed, thereby dispensing the aliquots of fluidic materials having substantially uniform densities.

In another aspect, the invention provides a method of dispensing a fluidic material. The method includes (a) providing a dispensing system having a fluid junction block comprising: (i) at least a portion of a first conduit that fluidly communicates with a first fluidic material source; (ii) at least a portion of a second conduit having: (I) at least first and second openings, and (II) at least one port disposed through a wall of the second conduit. The port communicates with a cavity disposed through the second conduit. Further, the first conduit intersects and fluidly communicates with the second conduit between the port and the second opening of the second conduit. The method also includes (b) conveying a volume of a second fluidic material through the first opening of the second conduit proximal to the port, (c) restricting fluidic material conveyance through the first opening of the second conduit and through the first conduit, and (d) conveying at least one gas into the second conduit through the port to purge fluidic materials from the second conduit downstream from the port through the second opening of the second conduit. In addition, the method also includes (e) restricting fluidic material conveyance through the first opening of the second conduit and gas conveyance through the port, (f) conveying a volume of a first fluidic material from the first fluidic material source through the first conduit and into the second conduit proximal to and downstream from the intersection of the first and second conduits such that a volume of the gas is disposed between the first and second fluidic materials in the second conduit, (g) restricting fluidic material conveyance through the first conduit and gas conveyance through the port, and (h) applying pressure to the second fluidic material in the second conduit such that at least one selected aliquot of the first fluidic material is dispensed from the second opening of the second conduit.

### BRIEF DESCRIPTION OF THE DRAWINGS

FIG. 1A schematically shows a dispensing system that includes a conduit coil according to one embodiment of the invention.

FIG. 1B schematically depicts a reservoir that is optionally substituted in the dispensing system of FIG. 1A.

FIG. 2 schematically depicts a dispensing system according to one embodiment of the invention.

FIG. 3 schematically shows a dispensing system according to one embodiment of the invention.

FIG. 4 schematically illustrates a dispensing system according to one embodiment of the invention.

FIG. 5A schematically shows a cross-sectional view through a dispensing system according to one embodiment of the invention.

FIG. 5B schematically depicts a detailed cross-sectional view of a fluid junction block from the dispensing system of FIG. 5A.

FIG. 6 schematically illustrates a dispense head that includes a fluid manifold according to one embodiment of the invention.

FIG. 7A schematically shows a dispensing system from a perspective view according to one embodiment of the invention.

FIG. 7B schematically illustrates a detailed bottom perspective view of a dispensing component from the dispensing system of FIG. 7A.

FIG. 7C schematically depicts a detailed top perspective view of a dispensing component from the dispensing system of FIG. 7A.

FIG. 8 schematically shows a multi-channel peristaltic pump from a top perspective view.

FIG. 9 schematically depicts an object holder from a top perspective view.

FIG. 10A schematically shows a top view of a microtiter plate.

FIG. 10B schematically illustrates a bottom view of the microtiter plate shown in FIG. 10A.

FIG. 10C schematically depicts a cross-sectional view of the microtiter plate shown in FIG. 10A.

FIG. 11A schematically shows a partially transparent perspective view of a vacuum chamber of a cleaning component according to one embodiment of the invention.

FIG. 11B schematically illustrates a detailed cross-sectional view of a dispensing tip disposed proximal to an orifice of a portion of the vacuum chamber of FIG. 11A.

FIG. 12 schematically shows a representative example logic device in which various aspects of the present invention may be embodied.

### DETAILED DESCRIPTION

I. Introduction

While the present invention will be described with reference to a few specific embodiments, the description is illustrative of the invention and is not to be construed as limiting the invention. Various modifications can be made to the embodiments of the invention described herein by those skilled in the art without departing from the true scope of the invention as defined by the appended claims. It is also noted here that for a better understanding, certain like components are designated by like reference letters and/or numerals throughout the various figures. Further, unless defined otherwise, all technical and scientific terms used herein have the same meaning as commonly understood by one of ordinary skill in the art to which the invention pertains. Certain terms defined herein, and grammatical variants thereof, are more fully defined by reference to the specification in its entirety.

The present invention relates to accurate and efficient fluidic material dispensing. The term “fluidic material” refers to matter in the form of gases, liquids, semi-liquids, pastes, and combinations of these physical states. Exemplary fluidic materials include reagents for performing a given assay or synthesis reaction, suspensions of cells, beads, or other particles, and/or the like. The invention provides dispensing systems that include peristaltic pumps in addition to other pressure sources for delivering selected volumes of fluidic materials into various types of containers, onto substrate surfaces, and to other fluidic material sites. In some embodiments, these systems are further configured to dispense volumes of fluid that have substantially uniform densities. The term “substantially uniform densities” refers to densities that are approximately equal to one another. In some embodiments, for example, the densities of fluidic materials (e.g., solutions with particle suspensions, etc.) with substantially uniform densities vary by about 20% or less from one another. To illustrate, dissolved solutions are generally uniformly dense at equilibrium, whereas the density of solutions with particle suspensions may vary due, e.g., to improper mixing or settling. Density variations among volumes of dispensed fluids can, for example, generate biased assay results, cause synthetic protocols to produce inconsistent yields, or otherwise negatively impact the reproducibility of a particular application. In addition, the dispensing systems described herein typically include fluid junction blocks for introducing gases into system conduits, e.g., to purge fluids from the conduits, to create gaps between system and source fluids disposed in the conduits, or the like.

In addition to the dispensing systems described herein, system software for controlling the operation of these systems and related methods of dispensing fluidic materials are also provided.

II. Dispensing Systems

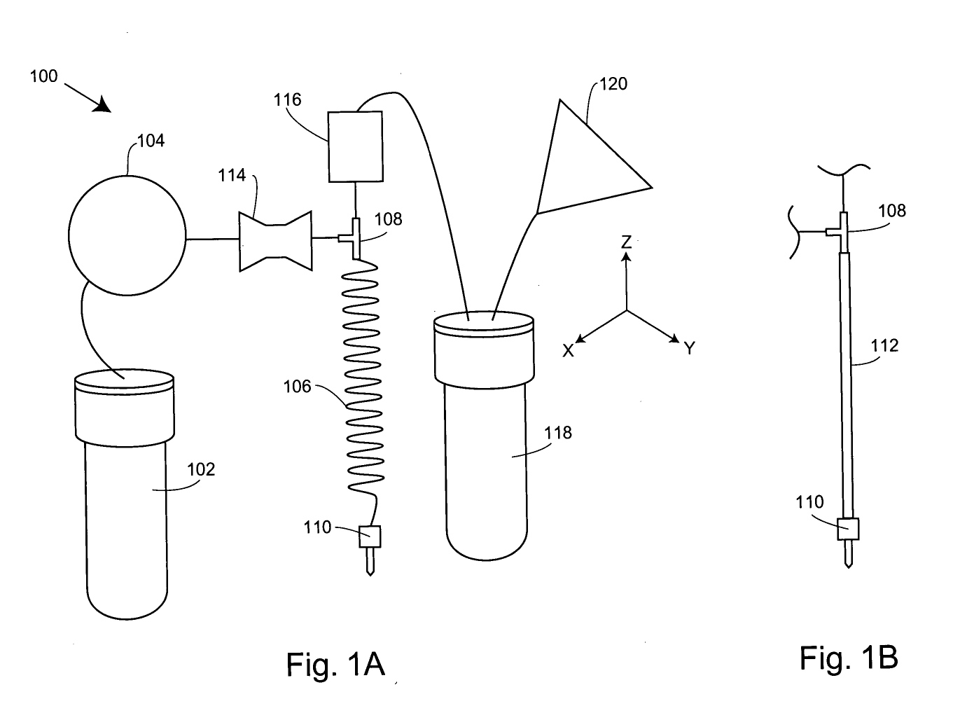

Referring initially to FIGS. 1-7, which schematically illustrate some embodiments of the dispensing systems of the invention. For example, FIG. 1A schematically shows dispensing system 100. As shown, dispensing system 100 includes fluidic material source 102 in fluid communication with peristaltic pump 104. As used herein, the term “fluid communication” or “fluidly communicate” in the context of dispensing system components refers to the ability of fluidic materials (e.g., liquids, gases, etc.) to be conveyed between those components. In some embodiments, system components fluidly communicate with one another via tubing or other conduits, whereas in other embodiments, at least some system components are directly connected with one another and fluidly communicate with one another in the absence of, e.g., tubing. As shown in FIG. 1A, components of dispensing system 100 fluidly communicate with one another via conduits.

During operation, peristaltic pump 104 flows fluidic material (e.g., bead suspensions, cell suspensions, etc.) from fluidic material source 102 into reservoir 106 via “T” junction 108. In some embodiments, the fluidic material flowed from fluidic material source 102 displaces existing buffer or other fluids disposed in reservoir 106, which fluids are directed to, e.g., a waste collection component (e.g., a waste tray, etc.) (not shown) of dispensing system 100. Once a selected volume of the fluidic material is flowed into reservoir 106, pinch valve 114 is typically engaged to restrict flow between peristaltic pump 104 and “T” junction 108. As shown, reservoir 106 also fluidly communicates with dispensing tip 110. As also shown, reservoir 106 includes a conduit coil in which the coils are disposed other than parallel with the Z-axis of dispensing system 100 so that fluidic materials flowed through reservoir 106 follow a non-vertical flow path. The term “non-vertical flow path” refers to a flow path that is not directly or entirely vertical (e.g., entirely parallel with a Z-axis). Non-vertical flow paths prevent beads, cells, or other particles in the fluidic materials from settling towards the bottom of reservoir 106. This provides a substantially uniform density to the fluidic material disposed in reservoir 106. Coiled reservoir design will vary depending on, e.g., the density of fluidic materials to be dispensed from dispensing tip 110. As used herein, the term “top” refers to the highest point, level, surface, or part of a device or system, or device or system component, when oriented for typical designed or intended operational use, such as dispensing fluidic materials. In contrast, the term “bottom,” as used herein, refers to the lowest point, level, surface, or part of a device or system, or device or system component, when oriented for typical designed or intended operational use.

In some embodiments, reservoirs having substantially vertical flow paths are utilized, e.g., for dispensing applications in which the uniformity of fluid density is typically not a concern, such as dissolved solution dispensing. An example of such a reservoir is schematically shown in, e.g., FIG. 1B. As shown, reservoir 112, which is shown as a tube lacking coils, can be substituted for reservoir 106 in dispensing system 100. Reservoir 112 typically includes a sufficient volume capacity to handle a series of dispenses from dispensing tip 110. In certain embodiments, reservoirs are designed to minimize mixing between source and system fluids. In other embodiments, source and system fluids are intentionally mixed to produce fluidic materials of selected concentrations for dispensing. Each of these embodiments is described further herein.

As additionally shown in FIG. 1A, dispensing system 100 also includes valve 116 (e.g., a solenoid valve, a syringe valve, etc.) in fluid communication with “T” junction 108 and pressurized fluidic material source 118, which typically contains a system fluid (e.g., a buffer or the like). Pressurized fluidic material source 118 also fluidly communicates with gas source 120, which applies pressure on fluidic materials disposed in pressurized fluidic material source 118. In some embodiments, reservoir 106 is primed with fluid from pressurized fluidic material source 118 prior to dispensing fluid from dispensing system 100. In certain embodiments, after fluidic material is flowed from fluidic material source 102 into reservoir 106, valve 116 is typically opened such that a calculated volume of fluid from pressurized fluidic material source 118 is added behind the fluidic material disposed in reservoir 106, e.g., to ensure that any waste fluids are eliminated from dispensing tip 110 (e.g., directed to a waste collection component) and that the fluidic material from fluidic material source 102 is disposed in, and ready to be dispensed from, dispensing tip 110. Dispensing tip 110 is then typically moved by a positioning component (not shown) of dispensing tip 110 over a fluidic material site (e.g., a well of a multi-well container, a surface of a substrate, etc.) at which a selected volume of the fluidic material is to be dispensed. Optionally, materials sites are moved relative to dispensing tips in the systems described herein. Once so positioned, valve 116 is typically opened for an amount of time that is sufficient to dispense the selected volume of the fluidic material. This process is generally repeated until all selected volumes have been dispensed or until additional fluidic material from fluidic material source 102 needs to be added to reservoir 106. In this process, fluid from pressurized fluidic material source 118 displaces the fluidic material from in reservoir 106 to effect dispensing from dispensing tip 110.

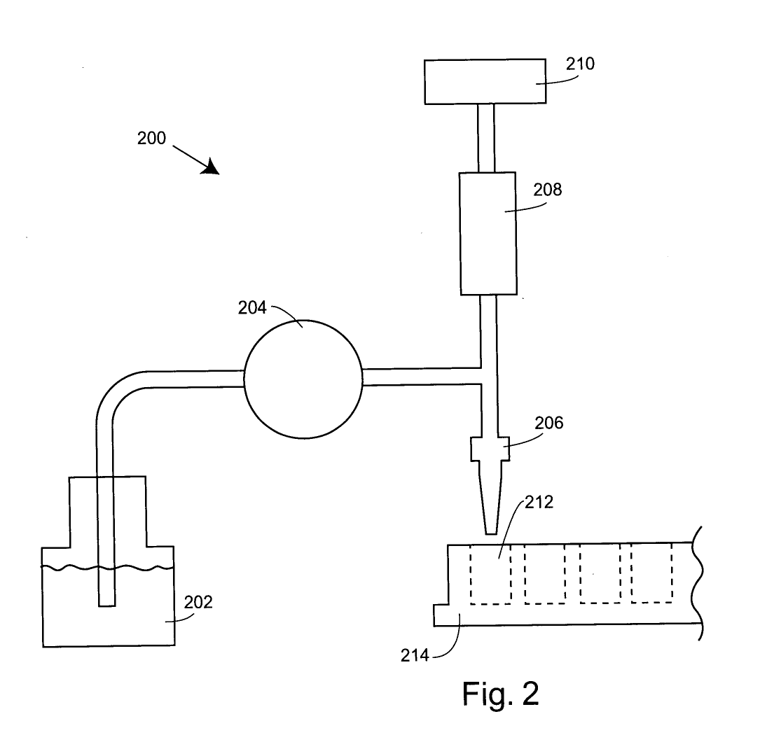

To further illustrate other embodiments, FIG. 2 schematically depicts dispensing system 200, which includes fluidic material source 202 in fluid communication with peristaltic pump 204. In addition, dispensing system 200 includes dispensing tip 206 in fluid communication with peristaltic pump 204. Dispensing tip 206 also fluidly communicates with valve 208 and pressurized gas source 210. During operation, peristaltic pump 204 typically conveys fluidic material from fluidic material source 202 to dispensing tip 206. The volume of fluidic material conveyed to dispensing tip 206 is generally equal to the volume a user selects to be dispensed from dispensing system 200. When valve 208 is opened, the pressure applied by pressurized gas source 210 forces the selected volume of fluidic material from dispensing system 200 into well 212 of multi-well container 214. In automated formats, this process is typically repeated, e.g., until all selected wells of multi-well container 214 are dispensed into.

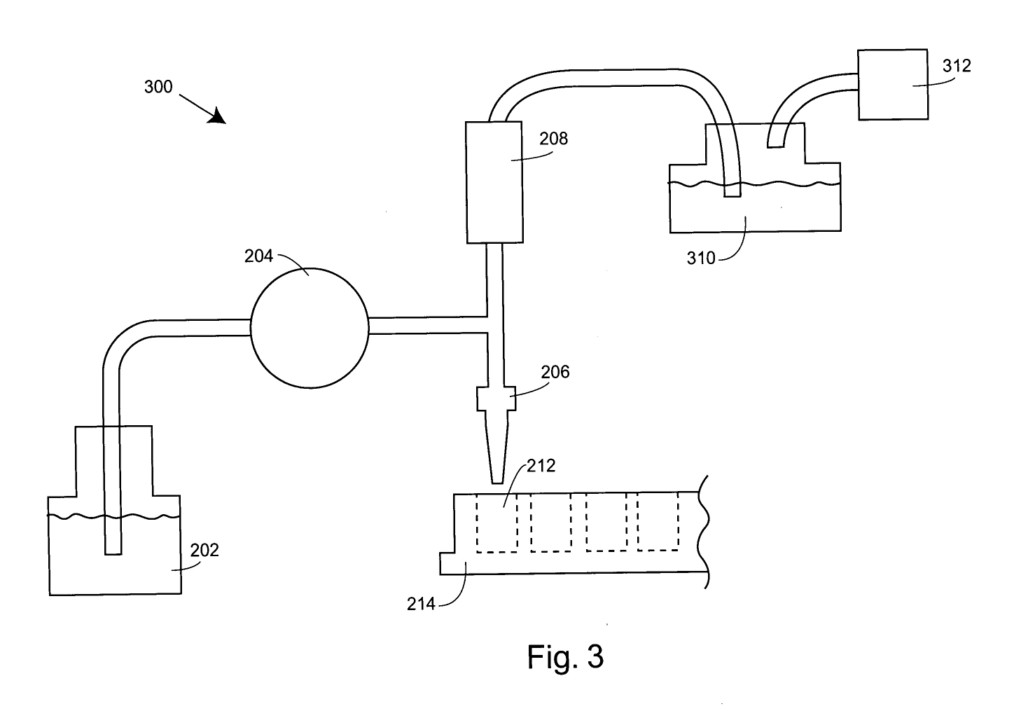

FIG. 3 schematically illustrates a variant of dispensing system 200, described above. In the embodiment shown, valve 208 is in fluid communication with pressurized fluidic material source 310, which fluidly communicates with pressurized gas source 312 of dispensing system 300. In some embodiments, a solvent disposed in pressurized fluidic material source 310 is the same solvent included in fluidic material source 202. As used herein, the term “solvent” refers to a liquid substance capable of dissolving or dispersing one or more other substances or something that provides a solution. In these embodiments, the solution contained in fluidic material source 202 is typically concentrated (e.g., a concentrated bead solution, etc.). During operation, peristaltic pump 204 conveys the concentrated solution to dispensing tip 206. When valve 208 is opened, solvent flows from pressurized fluidic material source 310 to dilute the volume of concentrated solution disposed in dispensing tip 206 to a selected level. In addition, the solvent flow from pressurized fluidic material source 310 also causes the diluted solution to be dispensed from dispensing tip 206 into well 212 of multi-well container 214. As above, this process can be repeated until volumes of solution have been dispensed into all selected wells of multi-well container 214.

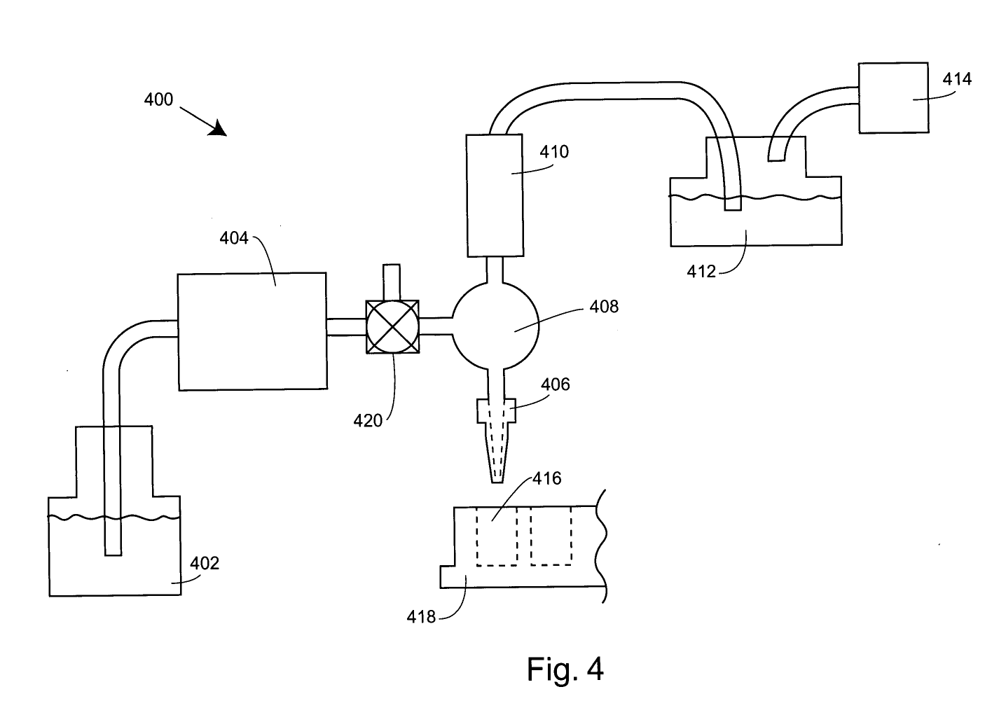

FIG. 4 schematically illustrates another exemplary embodiment of a dispensing system. As shown, dispensing system 400 includes fluidic material source 402 in fluid communication with peristaltic pump 404. In addition, dispensing system 400 includes dispensing tip 406 in fluid communication with peristaltic pump 404 via mixing chamber 408. Dispensing tip 406 also fluidly communicates with valve 410 via mixing chamber 408. Valve 410 also fluidly communicates with pressurized fluidic material source 412, which fluidly communicates with pressurized gas source 414 of dispensing system 400. In certain applications, dispensing system 400 is used to continuously dispense fluidic material into wells of multi-well containers or at other fluidic material sites. In these embodiments, peristaltic pump 404 and valve 410 are generally run simultaneously with one another. To illustrate, peristaltic pump 404 typically continuously delivers a concentrated fluidic material or solution from fluidic material source 402 into mixing chamber 408. Solvent contained in pressurized fluidic material source 412 is typically the same as that used in the concentrated solution contained in fluidic material source 402. Control software typically controls the opening and closing of valve 410 so that the diluting solvent enters mixing chamber 408 from pressurized fluidic material source 412 to dilute the concentrated solution conveyed from fluidic material source 402 by a selected amount. As fluids are conveyed into mixing chamber 408, selected volumes of diluted solution are also dispensed from dispensing tip 406 into selected wells 416 of multi-well container 418.

As also shown in FIG. 4, dispensing system 400 also includes three-way valve 420 disposed between and in fluid communication with peristaltic pump 404 and mixing chamber 408. When three-way valve 420 is actuated, the line to peristaltic pump 404 is vented to atmosphere. Further, peristaltic pump 404 is optionally run in reverse such that concentrated solution in the line is returned to fluidic material source 402. This can be important, for example, when expensive materials are being dispensed from fluidic material source 402 and waste is to be minimized. Three-way valves are also optionally included in other embodiments of these dispensing systems.

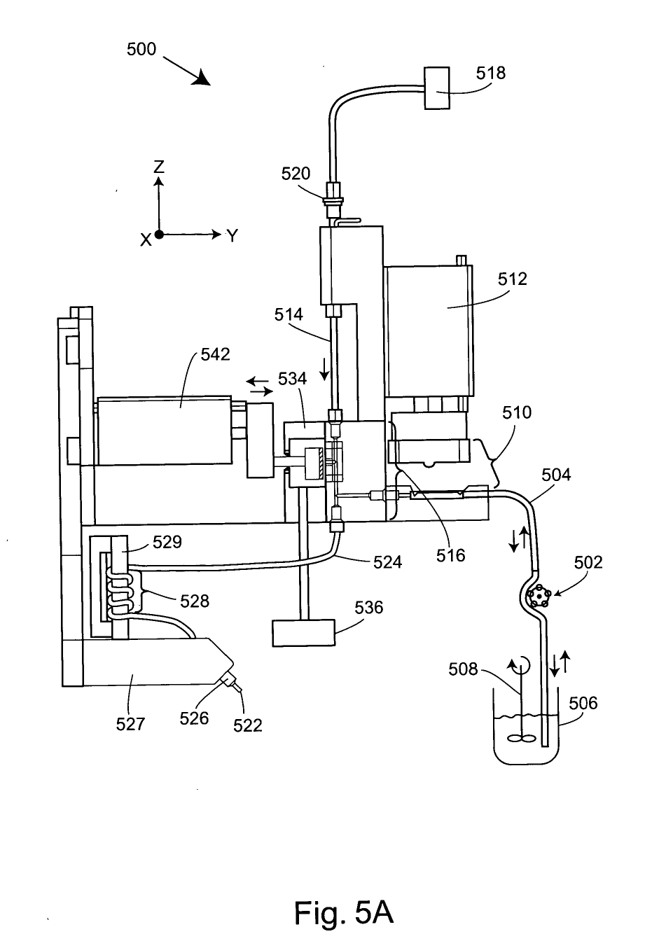

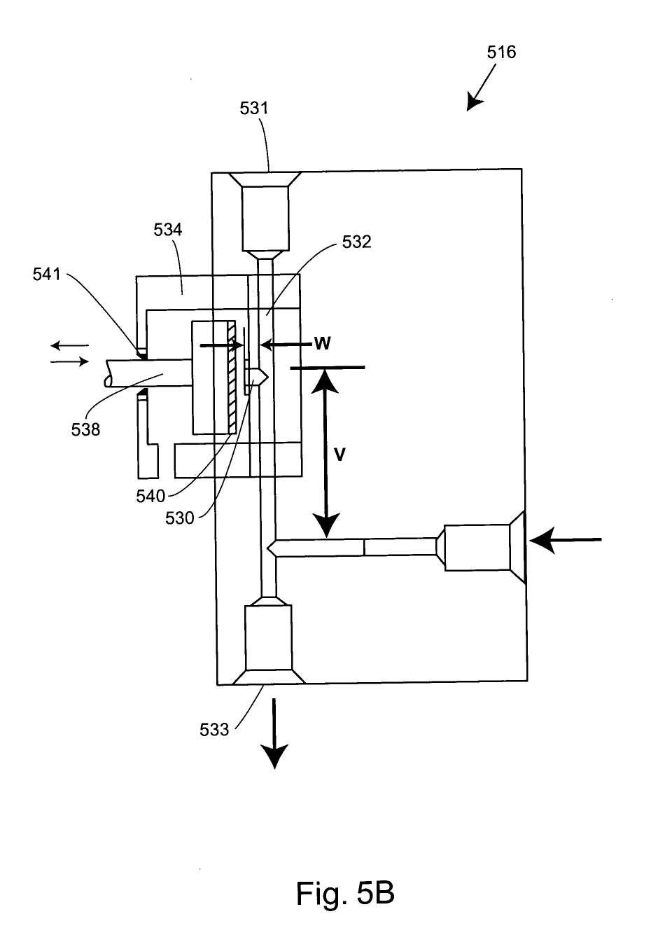

To further illustrate, FIG. 5A schematically shows a cross-sectional view of dispensing system 500. As shown, dispensing system 500 includes peristaltic pump 502 operably connected to first conduit 504, which fluidly communicates with first fluidic material source 506. Peristaltic pump 502 is configured to reversibly convey a first fluidic material (e.g., a bead suspension, a cell suspension, reagents, etc.) into or through at least a portion of first conduit 504. As used herein, the term “reversibly convey” refers to a process of conveying material in which the material or portions thereof are capable of being, e.g., removed from a fluidic material site after being dispensed at the site, dispensed at one fluidic material site after being removed from another fluidic material site, and/or the like. In certain embodiments, for example, fluidic materials are aspirated from fluidic material sites (e.g., wells of a micro-well plate or other fluidic material source) and dispensed at other sites (e.g., wells of a micro-well plate, surfaces of substrates, fluidic material waste containers, etc.). Reversible material conveyance is typically effected by rotating the peristaltic pump roller support in a direction that is opposite from the direction the roller support is rotated to convey the material to the particular fluidic material site from which the material is removed. As also shown, fluid agitation mechanism 508 is operably connected to first fluidic material source 506 to prevent components (e.g., beads, cells, etc.) of the first fluidic material from settling toward the bottom of first fluidic material source 506 and to otherwise mix the components of the first fluidic material. Mixing of components in first fluidic material source 506 can be achieved during operation of dispensing system 500 using various approaches including, e.g., aspiration and dispensing, impeller movement, ultrasonics, physical shaking, and the like. Suitable fluid agitation mechanisms, such as impellers are readily available from many different commercial suppliers including, e.g., Bellco Glass, Inc. (Vineland, N.J., USA), Philadelphia Mixing Solutions (Palmyra, Pa., USA), and the like.

As further shown in FIG. 5A, dispensing system 500 also includes pinch valve 510, which is configured to regulate conveyance of fluidic materials through first conduit 504. Air table 512 is operably connected to the pinch valve 510 and effects operation of pinch valve 510.

Dispensing system 500 also includes second conduit 514, which fluidly communicates with first conduit 504 via fluid junction block 516. Second conduit 514 also fluidly communicates with pressure source 518 (e.g., a pressurized gas source, a pressurized second fluidic material source, a pump, etc.) via valve 520 (e.g., a microsolenoid valve, etc.). Pressure source 518 is configured to apply pressure in second conduit 514 such that selected aliquots of the first fluidic material are dispensed from opening 522 in third conduit 524. To illustrate, pressure sources optionally comprise pressurized fluidic material sources that include buffers or other fluids used as system fluids. Valve 520 regulates pressure applied by pressure source 518.

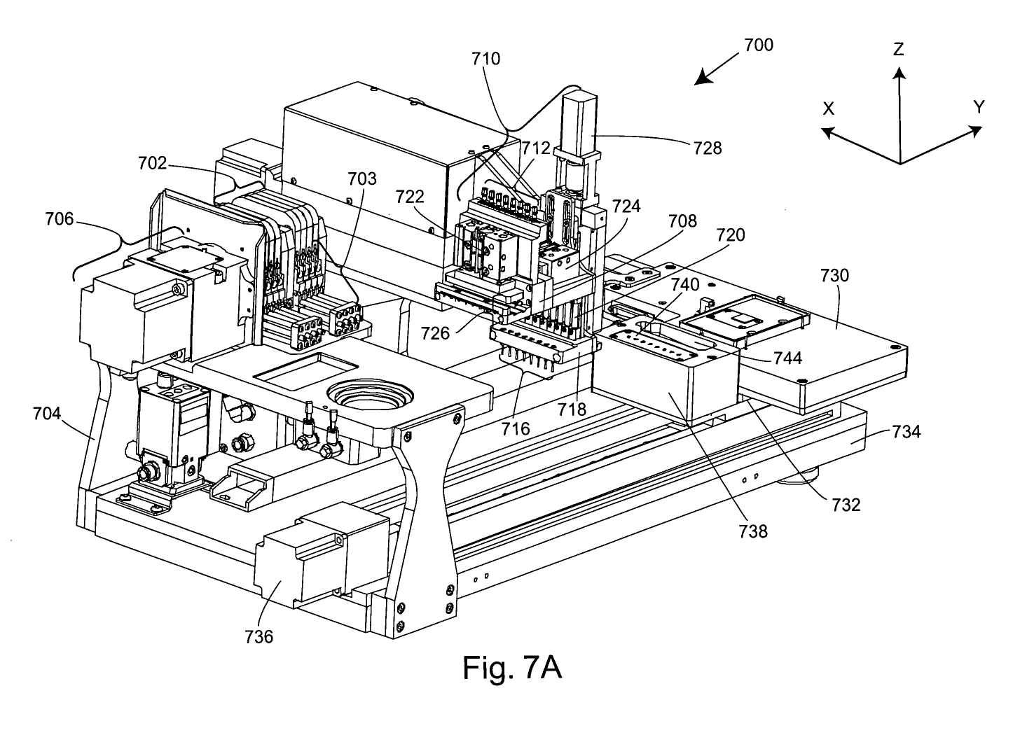

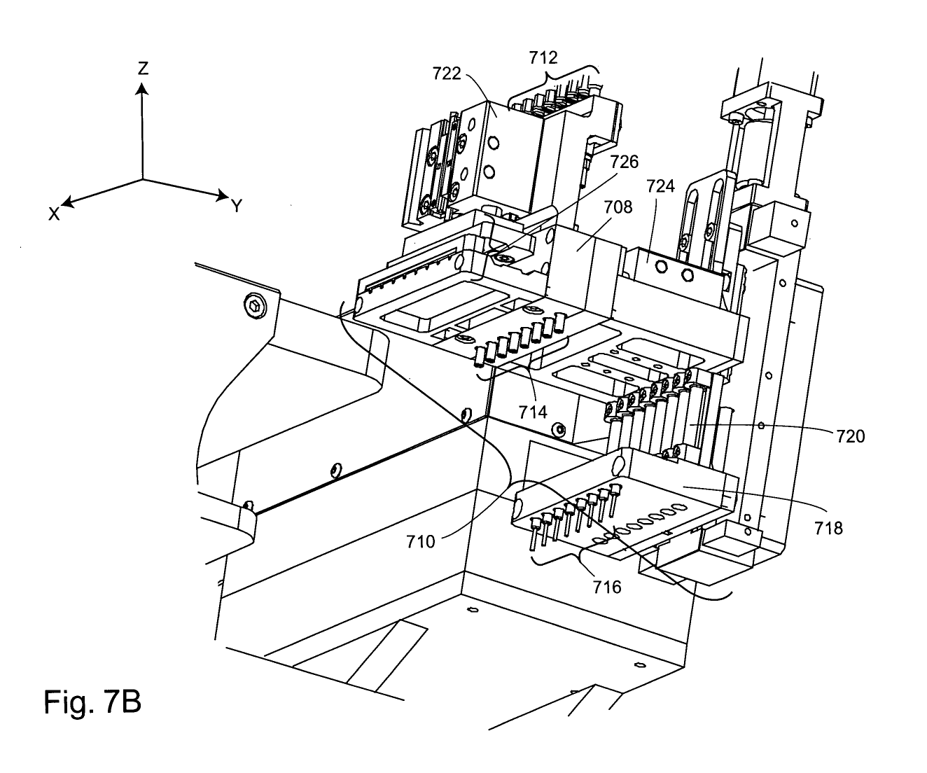

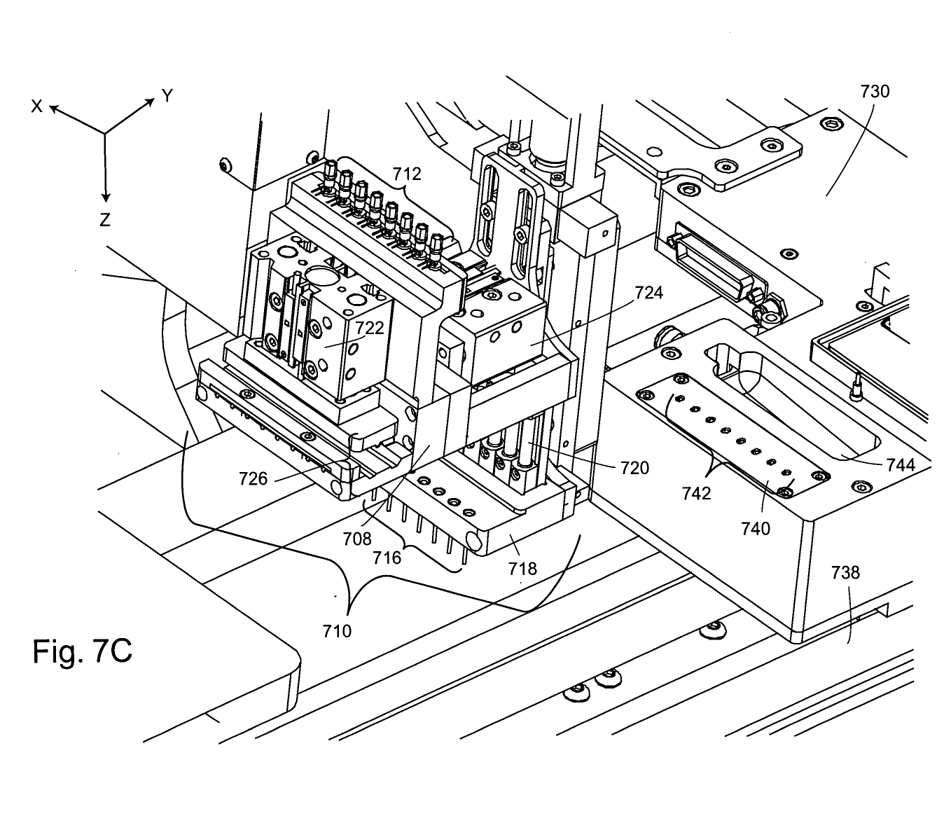

As shown, dispensing tip or nozzle 526 is disposed in dispense head 527 and fluidly communicates with third conduit 524 and includes opening 522 in third conduit 524. In some embodiments, the segment of, e.g., third conduit 524 that includes opening 522 is disposed at an angle of between about 0° and about 90° relative to the Z-axis of dispensing system 500, more typically disposed at an angle of between about 15° and about 75° relative to the Z-axis, and still more typically disposed at an angle of between about 35° and about 55° (e.g., about 40°, about 41°, about 42°, about 43°, about 44°, about 45°, about 46°, about 47°, about 48°, about 49°, etc.) relative to the Z-axis. As also shown in FIG. 5A, the segment of third conduit 524 that includes opening 522 is disposed at an about a 45° angle relative to the Z-axis of dispensing system 500. For example, fluids dispensed into the wells of multi-well containers from conduits having this configuration typically contact the sides of the wells before other parts of the wells. This minimizes the disruption of other materials, such as beads, cells, etc. disposed in the wells during fluid dispensing. These conduit and tip configurations also assist in maintaining the uniform densities of dispensed solutions by providing non-vertical flow paths in these regions. In certain embodiments, dispensing tips are disposed substantially parallel to the Z-axis. Dispensing tips 716 of dispensing system 700 (see, e.g., FIG. 7A) schematically illustrate one embodiment of this configuration, which can help to prevent droplets of solution from forming on the tips. Dispensing system 700 is described further below.

As referred to above, a substantial portion of a conduit is disposed other than parallel to a Z-axis in certain embodiments of the dispensing systems described herein. To illustrate, third conduit 524, which forms a fluid reservoir in dispensing system 500, includes conduit coil 528. As shown, conduit coil 528 includes multiple coils that are disposed around vertically mounted posts 529 other than parallel to the Z-axis of dispensing system 500. As also shown, other segments of third conduit 524 are also disposed other than parallel to the Z-axis of dispensing system 500. This conduit orientation prevents beads, cells, or other materials in fluids to be dispensed from settling toward opening 522 in third conduit 524 such that volumes having uniform densities are dispensed from third conduit 524.

Now referring additionally to FIG. 5B, which schematically depicts a detailed cross-sectional view of fluid junction block 516 of dispensing system 500. As shown, port 530 is disposed through a wall of fluid junction block conduit 532 and communicates with the cavity disposed through fluid junction block conduit 532. Gas valve 534 is operably connected to port 530. Gas valve 534 is also operably connected to a pressurized gas source 536 and regulates gas flow into fluid junction block conduit 532 through port 530. Gas valve 534 is generally used to introduce gaseous gaps between fluids disposed in fluid junction block conduit 532 to prevent those fluids from mixing with one another in fluid junction block conduit 532. In some embodiments, for example, such gaps fill the portion of fluid junction block conduit 532 corresponding to distance V shown in FIG. 5B. Although other distances can be utilized, distance V is typically between about 5 mm and about 50 mm, and more typically between about 10 mm and 25 mm. Typically, pressurized gas source 536 flows gas (e.g., air, nitrogen, helium, argon, etc.) to gas valve 534 at a pressure of between about zero pounds per square inch and about 10 pounds per square inch. In embodiments where the openings to dispensing tips are large enough to permit fluids to be pulled from the tips under the force of gravity when gas valves are open, an applied pressure is optionally not utilized to push the fluids from these tips. Methods of introducing gas into fluid junction block conduits to create these gaseous gaps are described further below.

Gas valve 534 is designed so that a minimal dead volume of gas is introduced into a fluid stream in fluid junction block conduit 532 during a dispense cycle. This low dead volume of gas is achieved by minimizing the distance or length W. More specifically, port 530 typically includes a length W of about 5 mm or less, more typically a length W of about 2.5 mm or less, and still more typically a length W of about 1 mm or less (e.g., about 0.9 mm, about 0.7 mm, about 0.5 mm, about 0.3 mm, about 0.1 mm, etc.).

As also shown, gas valve 534 includes plunger 538, which includes compliant seal material 540 that forms a face seal with port 530 when plunger 538 pushes compliant seal material 540 into contact with port 530. Essentially any chemically resistant rubber or elastomeric material, many of which are well known in the art, is optionally adapted for use as a compliant seal material. For example, suitable compliant seal materials are optionally selected from, e.g., KALREZ®, VITON®, SANTOPRENE®, TEFLON®, CELERUS™, or the like. Many of these materials are readily available from various commercial suppliers, such as W.L. Gore & Associates (Newark, Del.). In addition, gas valve 534 also includes linear seal 541 disposed around plunger 538. Linear seal 541 prevents gas from escaping from gas valve 534 around plunger 538.

Dispensing system 500 also includes air table 542 operably connected to gas valve 534. Air table 542 is configured to move plunger 538 to effect operation of gas valve 534.

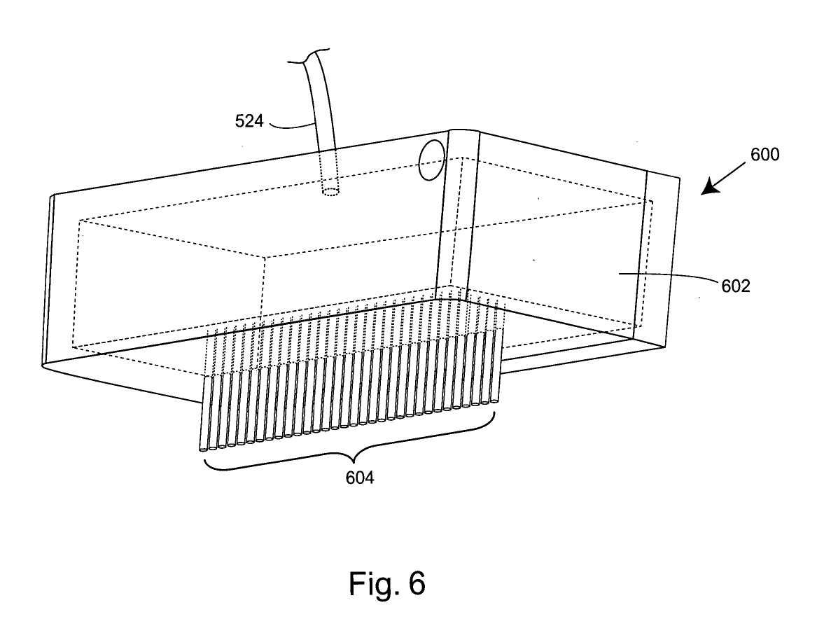

To further illustrate, the dispensing systems described herein include multiple conduits (e.g., 2, 3, 4, 5, 6, 7, 8, 9, 10, 11, 12, 13, 14, 15, or more conduits) in certain embodiments. In some of these embodiments, for example, the openings in at least two of the conduits are spaced at a distance from one another to simultaneously fluidly communicate with different wells disposed in a multi-well container (e.g., multi-well containers having 2, 4, 6, 12, 24, 48, 96, 384, 1536, or more wells). Dispensing system 700 (described further below), for example, includes eight conduits, which are spaced at distances from one another to simultaneously dispense fluidic materials into standard 384-well plates having 16×24 arrays of wells. In some embodiments, dispensing systems include manifolds that fluidly communicate with single conduits. These manifolds are also typically configured to fluidly communicate with multiple fluidic material sites, e.g., multiple wells disposed in a multi-well plate, a reaction block, etc. For example, manifolds include dispensing tips that are spaced at distances from one another to simultaneously dispense fluidic materials into different wells disposed in a multi-well container, onto substrate surfaces, or the like. To further illustrate, FIG. 6 schematically illustrates dispense head 600 that includes manifold 602, which is shown as a chamber that fluidly communicates with dispensing tips 604 and a conduit. In certain embodiments, for example, dispense head 600 replaces dispense head 527 in dispensing system 500 such that third conduit 524 fluidly communicates with manifold 602. During operation, fluidic materials are conveyed from third conduit 524 into manifold 602 and dispensed from dispensing tips 604.

To further illustrate aspects of the invention, FIGS. 7 A-C schematically depict dispensing system 700 according to one embodiment of the invention. As shown, dispensing system 700 includes peristaltic pump 702 (e.g., a multi-channel low volume peristaltic pump) mounted on mounting component 704 (shown as a rigid frame). Dispensing system 700 also includes a feedback component that comprises drive motor 706, which typically includes a position encoder and gear reduction, and which is operably connected to peristaltic pump 702 to effect precisely controlled rotation of the rotatable roller support of peristaltic pump 702. The feedback component also includes a control system for drive motor 706 (not shown in FIG. 7) that is capable of position feedback control.

During operation, conduits (not shown in FIG. 7) are generally disposed between the compression surfaces and rollers of peristaltic pump 702. In addition, one set of termini of the conduits fluidly communicate with the same or different material sources (not shown in FIG. 7), while the other set of termini are operably connected to and fluidly communicate with fluid junction block 708 of dispensing component 710. An exemplary fluid junction block is also described above. As also shown, dispensing system 700 includes tube stretchers 703, which are designed to give the user fine adjustment over the flow rate of each peristaltic channel. More specifically, tube stretchers 703 mechanically increase the length of associated peristaltic tubing or conduits. As the length of a given tube is increased, the inner diameter of that tube decreases and the volume conveyed per pulse or rotational increment is also decreased. This gives the user a fine adjustment to the flow rate for each peristaltic channel. In some embodiments, further adjustments can be made by varying the spacing between peristaltic pump cartridges and rollers.

FIGS. 7 B and C schematically illustrate detailed bottom and top perspective views, respectively, of dispensing component 710 from dispensing system 700. Solenoid valves 712 fluidly communicate with the same or different pressure sources (not within view) (e.g., a pressurized gas source, a pressurized second fluidic material source, a pump, etc.) and with fluid junction block 708 via conduits (not shown in FIG. 7). Outlets 714 of fluid junction block 708 fluidly communicate with dispensing tips 716 disposed in dispense head 718 via conduits (not shown in FIG. 7), which conduits form conduit coils disposed around vertically mounted posts. Exemplary conduit coils are also described above. As also shown, dispensing component 710 also includes air tables 722 and 724. Air table 722 effects operation of pinch valve 726, whereas 724 is operably connected to a gas valve (not within view) of fluid junction block 708 to regulate the flow of gas into fluid junction block 708 to introduce gaseous gaps to prevent fluid mixing as described above.

In addition, dispensing component 710 of dispensing system 700 also includes Z-axis linear motion component 728 (e.g., a compact, high speed, short travel Z-axis motion component or system), which is a positioning component that effects Z-axis translation of dispensing tips 716 relative to fluidic material sites (e.g., multi-well plates, membranes, etc.) disposed on object holder 730. Object holder 730 is operably connected to X/Y-axis linear motion components 732 (shown as tables), which move object holder 730 relative to dispensing tips 716 along the X- and Y-axes. X/Y-axis linear motion components 732 are also mounted on support element 734, which forms part of mounting component 704. One or more motors (e.g., solenoid motors, etc.) are generally operably connected to the dispensing systems of the invention to effect motion of object holders on X/Y-axis linear motion tables. For example, solenoid motor 736 effects motion of object holder 730 in dispensing system 700. Although not within view in FIGS. 7 A-C, dispensing system 700 also generally includes control drives, e.g., for X/Y-axis linear motion components 732 and position feedback for drive motor 706. As also shown, cleaning component 738, which is used to clean dispensing tips 716 is also included. In particular, cleaning component 738 includes vacuum chamber 740 having orifices 742 that correspond to dispensing tips 716 such that when dispensing tips 716 are disposed proximal to orifices 742 under a vacuum applied by vacuum chamber 740, adherent material is removed at least from external surfaces of dispensing tips 716. Cleaning component 738 also includes fluid container 744 disposed next to vacuum chamber 740. In certain embodiments, fluid container 744 contains a cleaning solvent into which dispensing tips 716 can be lowered by Z-axis linear motion component 728, e.g., prior to applying a vacuum to dispensing tips 716 at vacuum chamber 740. Optionally, fluid container 744 is used as a waste collection component.

The dispensing systems of the invention also typically include controllers (also not shown in FIGS. 1-7) that are configured to effect rotation of peristaltic pump roller supports in selected rotational increments, to effect application of pressure from pressure sources, to effect motion of linear motion components, and/or the like. These and other aspects of the invention are described in greater detail below.

A. Peristaltic Pumps

The dispensing systems described herein generally include rotating peristaltic pumps with precisely regulated accelerations, velocities, and decelerations to effect accurate angular displacements. In certain embodiments, for example, these systems account for periodic variations produced, e.g., by roller disengagement events such that accurate and repeatable conveyance of fluidic material is achieved using rotary peristaltic pumps. The term “periodic variation” refers to a recurrent change in output or other characteristic of a given device or system. To illustrate, there is typically a periodic variation in the quantity of material conveyed by a rotary peristaltic pump, e.g., when a roller disengages from a material conduit during a displacement cycle. More specifically, there is generally a substantially linear relationship between angular displacement and the quantity of material conveyed during a displacement cycle when the lead roller (i.e., the roller whose contact with a material conduit is furthest advanced in a particular displacement cycle) applies constant pressure on the material conduit. However, this relationship tends to become non-linear as the lead roller undergoes a disengagement event during which the pressure applied by the lead roller on the material conduit decreases to zero. This produces a repeatable aberration or periodic variation in the function relating displaced quantity of material with angular displacement of the pump.

Essentially any rotary peristaltic pump can be used in the systems described herein. Peristaltic pumps typically use a turning mechanism to move fluids or other materials through a tube or other conduit that is compressed at a number of points in contact with, e.g., rollers, shoes, etc. of the pump such that the fluid is moved through the tube with each rotating motion. Peristaltic pumps generally include rotatable roller carriers or supports that support at least two rollers. In some embodiments, the controllers used in these systems are configured to rotate roller supports in rotational increments that substantially correspond to integral multiples of angular distances disposed between adjacent rollers supported on the roller supports such that quantities of fluidic materials that correspond to these rotational increments are conveyed into or through system conduits. In these embodiments, substantially identical roller disengagement events generally occur for each conveyed volume of fluid, thereby minimizing roller disengagement as a source of variation among conveyed fluid volumes. Peristaltic pumps and related methods of pump control are also described in, e.g., U.S. Provisional Patent Application No. 60/527,125, entitled “MATERIAL CONVEYING SYSTEMS AND METHODS,” filed Dec. 4, 2003 by Mainquist et al., which is incorporated by reference.

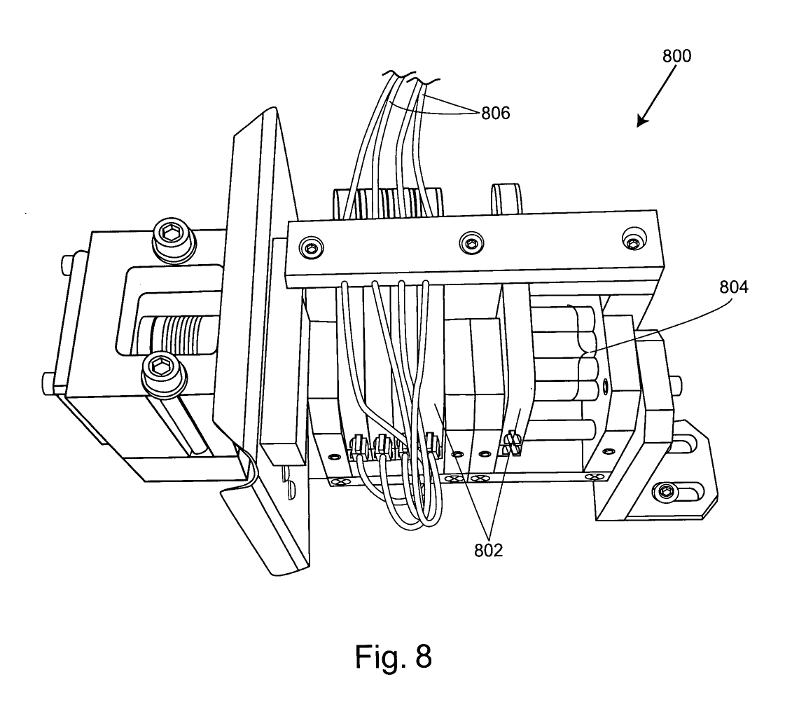

In some embodiments, for example, the peristaltic pump comprises a multi-channel peristaltic pump such that multiple quantities of material can be conveyed simultaneously. To illustrate, FIG. 8 schematically shows multi-channel peristaltic pump 800 from a top perspective view. In the embodiment shown, multi-channel peristaltic pump 800 comprises five channels 802. Optionally, additional channels 802 are added to multi-channel peristaltic pump 800, or one or more of channels 802 are removed from multi-channel peristaltic pump 800. Typically, the number of channels is selected to correspond to the number of dispensing tips to be utilized in a dispensing system for a particular dispensing application. Rollers 804 of the roller support of multi-channel peristaltic pump 800 and conduits 806 are also schematically shown in FIG. 8.

Although rotatable rollers (e.g., passively or actively rotatable) that rotate relative to roller supports are typically utilized in the systems of the invention, non-rotatable functionally equivalent components, such as fixed rollers or shoes are also optionally used. However, rotatable rollers generally produce less wear on material conduits (e.g., flexible tubing or the like) than non-rotatable equivalents for comparable amounts of usage.

Peristaltic pumps that can be adapted for use in the systems of the invention are available from a wide variety of commercial suppliers including, e.g., ABO Industries Inc. (San Diego, Calif., USA), Analox Instruments Ltd. (London, UK), ASF Thomas Industries GmbH (Puchheim, Germany), Barnant Co. (Barrington, Ill., USA), Cole-Parmer Instrument Company (Vernon Hills, Ill., USA), Fluid Metering Inc. (Syosset, N.Y., USA), Gorman-Rupp Industries (Bellville, Ohio, USA), I & J Fisnar Inc. (Fair Lawn, N.J., USA), Möller Feinmechanik GmbH & Co. (Fulda, Germany), PerkinElmer Instruments (Shelton, Conn., USA), Terra Universal Inc. (Anaheim, Calif., USA), and the like. Additional details relating to rotary pumps are described in, e.g., Karassik et al. (Eds.), Pump Handbook, The McGraw-Hill Companies (2000) and Nelik, Centrifugal and Rotary Pumps: Fundamentals with Applications, CRC Press (1999), which are both incorporated by reference.

B. Motion Control

The motion control systems used in the dispensing systems of the invention typically include matched components such as controllers, motor drives, motors, encoders and resolvers, user interfaces and software. Controllers, user interfaces, and software are described in greater detail below. Peristaltic pump drive motors generally include at least one position encoder and at least one gear reduction component. Exemplary motors utilized in the systems of the invention typically include, e.g., servo motors, stepper motors, or the like. In some embodiments, feedback components of the systems of the invention include at least one drive mechanism that is operably connected to the motor. The drive mechanism typically includes at least one control component that effects position feedback control of the motor.

As referred to above, the movement of peristaltic pump roller supports is typically effected by a motor operably connected to the pump. Exemplary motors that are optionally utilized in the systems of the invention include, e.g., DC servomotors (e.g., brushless or gear motor types), AC servomotors (e.g., induction or gearmotor types), stepper motors, linear motors, or the like. Servomotors typically have an output shaft that can be positioned by sending a coded signal to the motor. As the input to the motor changes, the angular position of the output shaft changes as well. Stepper motors generally use a magnetic field to move a rotor. Stepping can typically be performed in full step, half step, or other fractional step increments. Voltage is applied to poles around the rotor. The voltage changes the polarity of each pole, and the resulting magnetic interaction between the poles and the rotor causes the rotor to move.

The systems of the invention also generally include motor drives (e.g., AC motor drives, DC motor drives, servo drives, stepper drives, etc.), which act as interfaces between controllers and motors. In certain embodiments, motor drives include integrated motion control features. For example, servo drives typically provide electrical drive output to servo motors in closed-loop motion control systems, where position feedback and corrective signals optimize position and speed accuracy. Servo drives with integrated motion control circuitry and/or software that accept feedback, provide compensation and corrective signals, and optimizes position, velocity, and acceleration.

Suitable motors and motor drives are generally available from many different commercial suppliers including, e.g., Yaskawa Electric America, Inc. (Waukegan, Ill., USA), AMK Drives & Controls, Inc. (Richmond, Va., USA), Enprotech Automation Services (Ann Arbor, Mich., USA), Aerotech, Inc. (Pittsburgh, Pa., USA), Quicksilver Controls, Inc. (Covina, Calif., USA), NC Servo Technology Corp. (Westland, Mich., USA), HD Systems Inc. (Hauppauge, N.Y., USA), ISL Products International, Ltd. (Syosset, N.Y., USA), and the like. Additional detail relating to motors and motor drives are described in, e.g., Polka, Motors and Drives, ISA (2002) and Hendershot et al., Design of Brushless Permanent-Magnet Motors, Magna Physics Publishing (1994), which are both incorporated by reference.

C. Pressure Sources

The dispensing systems of the invention include pressure sources in addition to the peristaltic pumps that convey fluidic materials into the systems in preparation for dispensing. As described herein, these additional pressure sources are configured to apply pressure in system conduits such that selected aliquots of the fluidic materials that have been conveyed into the systems by the peristaltic pumps are forced or otherwise dispensed from the conduits. Essentially any pressure source can be adapted to effect fluidic material dispensing in this manner. To illustrate, pressure sources comprise pressurized gas sources that fluidly communicate with conduits from which fluidic materials are dispensed are used in certain embodiments. As schematically shown in FIG. 2, pressure source 210 is an example of this type of system configuration. A wide variety of pressurized gas can be utilized. In some embodiments, for example, air compressors are used to provide air pressure to force the selected aliquots from system conduits. Other gases, such as nitrogen, helium, argon, or the like are also optionally used to effect fluidic material conveyance. In certain embodiments, gas from pressurized gas sources is filtered (e.g., using 22 μm filters, etc.) to prevent contamination of the dispensing fluid by, e.g., bacteria, yeast, or the like. In some embodiments, these pressurized gas sources fluidly communicate with conduits from which fluidic materials are dispensed via one or more fluidic material sources, such as a system fluid source (e.g., a buffer or other solvent). In these embodiments, the pressurized gas typically forces fluidic material from these pressurized fluidic material sources into these conduits to effect the dispensing of selected fluidic material aliquots from the conduits. An example of this system configuration is schematically depicted in FIG. 1A, which is described further above. Various pumps, such as syringe pumps, other peristaltic pumps, etc. can also be configured to function as these pressure sources in the dispensing systems described herein.

The pressure applied by these pressure sources to effect dispensing of selected fluidic material aliquots can be regulated using a wide variety of techniques. In certain embodiments, for example, valves are positioned between pressure sources and the openings of conduits from which fluidic materials are dispensed. In some of these embodiments, solenoid valves, such as microsolenoid valves are utilized. Suitable valves are commercially available from various suppliers including, e.g., The Lee Company USA (Westbrook, Conn., USA). In these embodiments, valves are typically operably connected to controllers, which effect operation of the valves. Controllers are described in greater detail below.

D. Positioning and Mounting Components

In some embodiments, the dispensing systems of the invention include positioning components. Positioning components are generally structured to moveably position conduits and/or fluidic material sites relative to one another. Positioning components typically include at least one object holder that is structured to support the fluidic material site (e.g., a multi-well plate, a substrate, etc.). Typically, positioning components are operably connected to system controllers, which are configured to simultaneously effect fluidic material dispensing from conduits and moveably position the conduits and/or fluidic material sites relative to one another such that fluidic material volumes are conveyed to the fluidic material sites synchronous with the relative movement of the conduits and/or the fluidic material sites, e.g., to effect high throughput “on-the-fly” fluidic material dispensing.

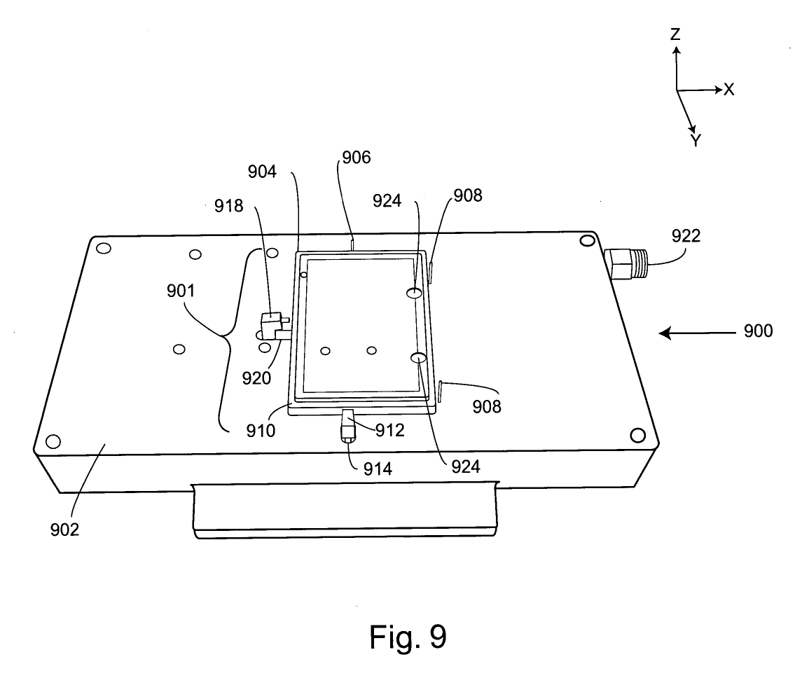

For positioning along two different axes, the object holders of the dispensing systems of the invention generally have one or more alignment members positioned to receive, e.g., each of the two axes of a multi-well container. For example, FIG. 9 shows a top perspective view of object holder 900 that can be used in the dispensing systems described herein. Another embodiment of an object holder (i.e., object holder 730) is schematically depicted in FIG. 7A, which is described further above. As shown in FIG. 9, container station 901 is disposed on support structure 902 of object holder 900. Support structure 902 supports vacuum plate 904. Protrusions 906 and 908 function as alignment members. The illustrated embodiment of the container station 901 has two x-axis protrusions 908 and one y-axis protrusion 906 extending from support structure 902. Accordingly, x-axis protrusions 908 and y-axis protrusion 906 are fixedly positioned relative to the vacuum plate 904, which, in this embodiment, acts to hold a multi-well container in position once it has been positioned. X-axis locating protrusions 908 are constructed to cooperate with an x-axis surface of a multi-well container (e.g., a y-axis wall of a microtiter plate), while y-axis protrusion 906 is constructed to cooperate with an y-axis surface of the container (e.g., a y-axis wall of a microtiter plate).

The alignment members can be, for example, locating pins, tabs, ridges, recesses, or a wall surface, and the like. In some embodiments, an alignment member includes a curved surface that contacts a properly positioned multi-well container. The use of a curved surface minimizes the effect of, for example, roughness of the container surface that contacts the alignment member. The use of two alignment members along one axis and one alignment member along the second axis, as shown in FIG. 9, is another approach to minimize the effect of surface irregularities on the proper positioning of the container. The multi-well container contacts three points along the surface of the container, so proper alignment is not dependent upon the entire container surface being regular.

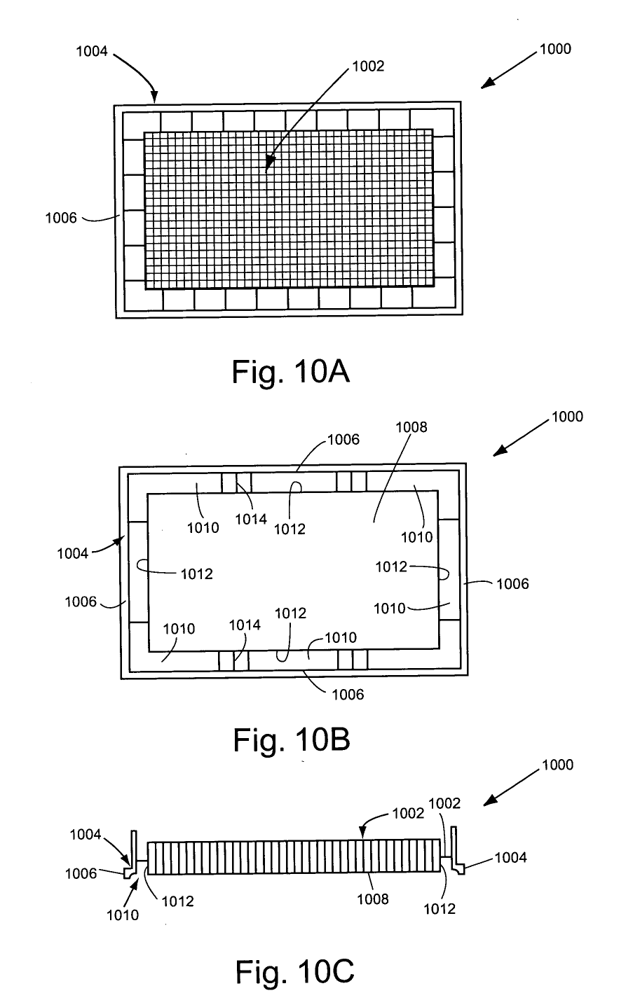

Certain embodiments of the invention apply specifically to the positioning of microtiter plates when used as the fluidic material sites. To illustrate, microtiter plate 1000 is shown in FIGS. 10A-C. As shown, microtiter plate 1000 comprises well area 1002, which has many individual sample wells for holding samples and reagents. Microtiter plates are available in a wide variety of sample well configurations, including commonly available plates with 6, 12, 24, 48, 96, 192, 384, 768, 1536, or more wells. It will be appreciated that microtiter plates are available from a various manufacturers including, e.g., Greiner America Corp. (Lake Mary, Fla., USA), Nalge Nunc International (Rochester, N.Y., USA), and the like. Microtiter plate 1000 has outer wall 1004 having registration edge 1006 at its bottom. In addition, microtiter plate 1000 includes bottom surface 1008 below the well area on the plate's bottom side. Bottom surface 1008 is separated from outer wall 1004 by alignment member receiving area 1010. Alignment member receiving area 1010 is bounded by a surface of outer wall 1004 and by inner wall 1012 at the edge of bottom surface 1008. Although there may be some lateral supports 1014 in alignment member receiving area 1010, these areas are generally open between inner wall 1012 and an inner surface of the outer wall 1004.

According to the invention, to position a microtiter plate the alignment members of the container station are optionally arranged to cooperate with inner wall 1012 of the microtiter plate. Inner wall 1012 is advantageously used, as inner wall 1012 is typically more accurately formed and is more closely associated with the perimeter of the sample well area, as compared to an outer wall of plate 1000, such as wall 1004. Accordingly, aligning an inner wall (e.g., inner wall 1012) of a microtiter plate relative to alignment members is generally preferred to aligning with an outer wall, such as wall 1004. The increased positioning precision that is obtained by using an inner wall as the alignment surface makes possible the use of high-density microtiter plates, such as 1536-well plates. Further, by having the alignment members (e.g., alignment protrusions 906 and 908) cooperate with an inner wall 1012 of plate 1000, minimal structures are needed adjacent the outside of the plate. In such a manner, a robotic arm or other transport device is able to readily access plate 1000. Having the protrusions positioned adjacent inner wall 1012 thereby facilitates translocating plate 1000. However, it will be appreciated that the alignment members or protrusions can be placed in alternative positions and still facilitate the precise positioning of the plate.

Object holders generally include one or more movable members. The movable members function to move a container against one or more alignment members. For example, once a multi-well container is placed in the general location of the alignment members, the movable members (termed “pushers” herein) move the container so that an alignment surface of the container is in contact with one or more of the alignment members of the positioning device. The positioning device can have pushers for positioning of the container along one or more axes. For example, a positioning device will often have one or more pushers that position a container along an x-axis, and one or more additional pushers that position the container along a y-axis. The pushers can be moved by means known to those of skill in the art. For example, air cylinders, springs, pistons, elastic members, electromagnets or other magnets, gear drives, and the like, or combinations thereof, are suitable for moving the pushers so as to move containers into a desired position.

One embodiment of a container station of an object holder having pushers for positioning a microtiter plate along both the x-axis and the y-axis is shown in FIG. 9. When the microtiter plate is generally positioned adjacent the x- and y-axis protrusions, the bottom surface of the microtiter plate is directly above top surface 910 of vacuum plate 904. Y-axis pusher 912, which extends through slot 914 in support structure 902, is used to apply pressure to a y-axis side wall of the microtiter plate. Sufficient force is applied to the plate to push the microtiter plate against y-axis protrusion 906. When the microtiter plate is pushed against y-axis protrusion 906, x-axis pusher 918, which extends through slot 920 of support structure 902, is used to push an x-axis wall of the microtiter plate towards x-axis protrusions 908. In this manner, the microtiter plate is accurately and precisely positioned relative both the x-axis and y-axis protrusions. It is sometimes advantageous, although not necessary, to have one or more of the pushers contact an inner wall of a microtiter plate rather than an outer wall. With this arrangement, the alignment members and pushers are underneath the microtiter plate. This leaves the area surrounding the exterior of the plate free of protrusions that could otherwise interfere with other devices that, for example, place the microtiter plate on the support.

As referred to above, the object holder embodiment shown in FIG. 9 includes vacuum plate 904 that functions as a retaining device to hold a properly positioned container in a desired position. With both y-axis pusher 912 and x-axis pusher 918 applying sufficient force to precisely place the microtiter plate, a vacuum source (not shown) applies a vacuum through vacuum line 922 into vacuum openings or holes 924. Air source (not shown) applies air pressure through an air line (not shown) to effect movement of the pushers.

In certain embodiments, positioning components also include X/Y-axis linear motion tables operably connected to position feedback control drives that control movement of the X/Y-axis linear motion tables along X- and Y-axes. In certain embodiments, linear motion tables are configured to move only along a single axis, such as an X-axis or a Y-axis. Typically, object holders are mounted on, e.g., X/Y-axis linear motion tables. As an example, FIG. 7A schematically shows object holder 730 mounted on X/Y-axis linear motion table 732. Positioning components also generally include Z-axis linear motion components that include dispense heads (see, e.g., dispense head 718 schematically shown in FIG. 7A) that supports portions of conduits and that move along the Z-axis. The Z-axis linear motion components generally include a solenoid motor or the like to effect movement of the dispense heads along the z-axis. In certain embodiments, Z-axis linear motion components also include material removal heads, e.g., mounted proximal to dispense heads. For example, certain material removal heads are configured to noninvasively remove materials from the wells of multi-well plates, e.g., to effect plate washing during certain applications. Material removal heads are typically structured to prevent cross-contamination among wells of multi-well plates as materials are removed from the plates. Additional details relating to material removal heads, systems and related methods, that are optionally adapted for use with the systems of the present invention are provided in, e.g., Provisional U.S. Pat. Appl. No. 60/461,638, entitled “MATERIAL REMOVAL DEVICES, SYSTEMS, AND METHODS,” filed Apr. 8, 2003 by Micklash II et al., which is incorporated by reference.

Various other positioning components or portions thereof can be utilized in the systems of the invention. In certain embodiments, for example, detectable signals produced at fluidic material sites (e.g., multi-well plates, substrate surfaces, etc.) disposed on the object holders of the systems described herein are detected. In some of these embodiments, orifices are disposed through object holders to facilitate such detection. To further illustrate, object holders optionally comprise nests in which multi-well plates or other fluidic material sites can be positioned in some embodiments of the invention. These or other types of object holders that can be utilized in the systems of the present invention are described in, e.g., International Publication No. WO 01/96880, entitled “AUTOMATED PRECISION OBJECT HOLDER,” filed Jun. 15, 2001 by Mainquist et al., U.S. Provisional Pat. Appl. No. 60/492,586, entitled “MULTI-WELL CONTAINER POSITIONING DEVICES AND RELATED SYSTEMS AND METHODS,” filed Aug. 4, 2003 by Evans, and U.S. Provisional Pat. Appl. No. 60/492,629, entitled “NON-PRESSURE BASED FLUID TRANSFER IN ASSAY DETECTION SYSTEMS AND RELATED METHODS,” filed Aug. 4, 2003 by Evans et al., which are each incorporated by reference.

In some embodiments, dispensing systems include mounting components that mount peristaltic pumps, pressure sources, controllers, positioning component, and/or other system components relative to one another. Mounting component are typically substantially rigid, e.g., fabricated from steel or other materials that can adequately support the other system components during operation of the system. An exemplary mounting component (i.e., mounting component 704) is schematically depicted in FIG. 7A, which is described further above.

E. Cleaning Components

The dispensing systems of the invention optionally also include cleaning components that are structured to clean conduits (e.g., dispensing tips thereof), e.g., when positioning components move the conduits at least proximal to the cleaning components. As fluidic materials are dispensed, some fluid can wick up or otherwise adhere to the outer surface of dispensing tips. This generally leads to additional wicking if the adherent fluid is not removed from the tips, because as the surface finish of a tip becomes coated with fluid it tends to attracts more fluid, e.g., during subsequent dispensing steps. Moreover, this also typically leads to inaccurate quantities of material being dispensed, since wicked materials are not dispensed at the selected fluidic material sites and/or are dispensed at non-selected sites. This inaccuracy may be compounded when multiple quantities of material are simultaneously dispensed from multiple material conduits, because fluidic material wicking tends to occur at different rates at the material conduit tips. Accordingly, wicked fluidic material is generally cleaned from material conduit tips, e.g., between dispensing steps using a cleaning component in certain embodiments of the invention.

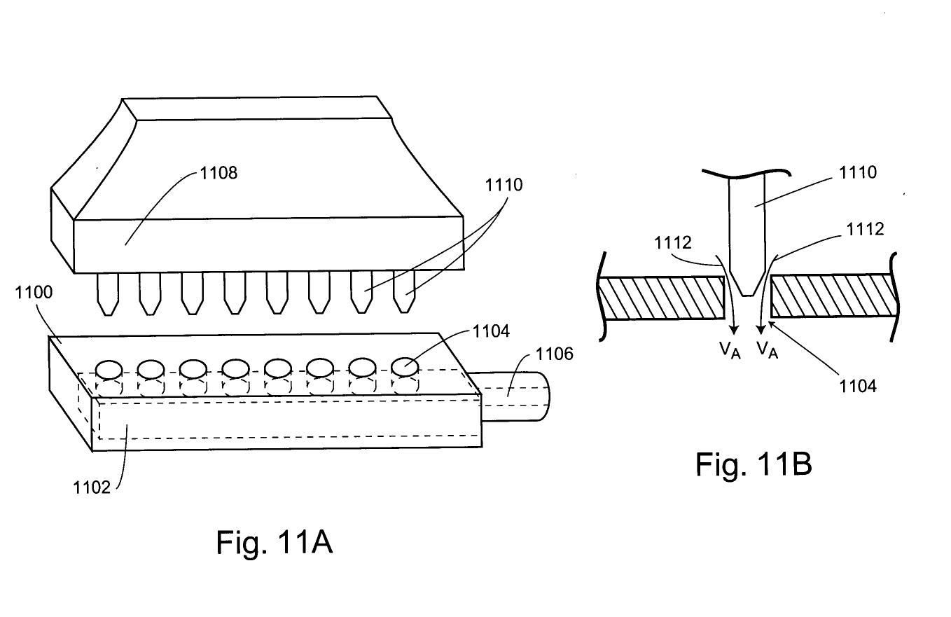

In some embodiments, for example, cleaning components include vacuum chambers that comprise at least one orifice into or proximal to which the positioning component moves the conduits such that an applied vacuum removes wicked or otherwise adherent material from external surfaces of the conduits or dispensing tips. Typically, outer cross-sectional dimensions of the conduits are smaller than cross-sectional dimensions of the orifices. To illustrate, FIG. 11A schematically shows a partially transparent perspective view of vacuum chamber 1102 of cleaning component 1100 according to one embodiment of the invention. As shown, multiple orifices 1104 are disposed in cleaning component 1100 and communicate with outlet 1106, which is typically operably connected to a vacuum source (not shown). Also shown is dispense head 1108 is disposed over cleaning component 1100. Orifices 1104 are structured to correspond to conduit tips 1110 of dispense head 1108 such that conduit tips 1110 can be lowered at least partially into orifices 1104 to effect removal of adherent materials from conduit tips 1110 under an applied vacuum. FIG. 11B schematically illustrates a detailed cross-sectional view of conduit tip 1110 disposed proximal to orifice 1104. Arrows 1112 represent the velocity of the air, V_{A}, flowing through orifice 1104. As conduit tip 1110 is lowered into orifice 1104, the area of orifice 1104 is decreased such that V_{A} increases in the gap that remains between vacuum chamber 1102 and conduit tip 1110 and pulls or otherwise removes adherent material from the outer surfaces of conduit tip 1110. Vacuum chambers are optionally disposed, e.g., on surfaces of object holders of the positioning components of the systems of the invention. In embodiments where dispensing tips are angled (see, e.g., dispensing tip 526, which is described further above), vacuum chamber orifices are typically modified to accommodate these tips. In some of these embodiments, for example, these orifices are fabricated as grooved openings.

F. Conduits

The conduits used in the systems of the invention include various embodiments. In some embodiments, for example, a terminus of a conduit includes a dispensing tip (e.g., a tapered tip, such as a nozzle or the like) that is fabricated integral with the conduit or is connected to the conduit, e.g., directly or via an insert. The size (e.g., internal cross-sectional dimension) of the conduit (e.g., pump tubing, etc.) and/or tip utilized is typically dependent, at least in part, on, e.g., the desired dispense volume, the viscosity of the fluidic material being conveyed, and the like. Although larger sizes are optionally utilized, cavities disposed through conduits and/or tips typically include, e.g., cross-sectional dimensions of between about 100 μm and about 100 mm, more typically between about 500 μm and about 50 mm, and still more typically between about 1 mm and about 10 mm. Optionally, cavities disposed through conduits or tips include at least two different cross-sectional dimensions.

Conduits, tips, and inserts are optionally fabricated from a wide variety of materials. Exemplary materials used to fabricated conduits, dispensing tips, and/or inserts include polypropylene, polystyrene, polysulfone, polyethylene, polymethylpentene, polydimethylsiloxane (PDMS), polycarbonate, polyvinylchloride (PVC), polymethylmethacrylate (PMMA), fluorinated ethylene propylene (FEP), polytetrafluoroethylene (PTFE) (TEFLON™), perfluoroalkoxy (PFA), autoprene, C-FLEX® (a styrene-ethylene-butylene (SEBS) modified block copolymer with silicone oil), NORPRENE® (a polypropylene-based material), PHARMED® (a polypropylene-based material), silicon, TYGON®, VITON® (includes a range of fluoropolymer elastomers), and the like. Dispensing tips and inserts are also optionally fabricated from other materials including glass and various metals (e.g., stainless steel, etc.). Materials for fabricating conduits, tips, and inserts are typically readily available from many different commercial suppliers including, e.g., Saint-Gobain Performance Plastics (Garden Grove, Calif., USA), DuPont Dow Elastomers L.L.C. (Wilmington, Del., USA), and the like.

G. Fluidic Material Sites

The systems and methods of the present invention can be adapted for use with essentially any type of fluidic material site. Typical fluidic material sites used in the systems of the invention include containers, substrate surfaces, and the like. Exemplary containers include multi-well containers, such as micro-well plates, reaction blocks, and other containers used, e.g., to perform multiple assays, synthesis reactions, or other processes in parallel. Multi-well containers such as these typically include, e.g., 6, 12, 24, 48, 96, 192, 384, 768, 1536, or more wells, and are generally available from various commercial suppliers including, e.g., Greiner America Corp. (Lake Mary, Fla., USA), Nalge Nunc International (Rochester, N.Y., USA), H+ P Labortechnik AG (Oberschleiβheim, Germany), and the like. Additional details relating to reaction blocks that are suitable for use in the systems of the invention are provided in, e.g., International Publication No. WO 03/020426, entitled “PARALLEL REACTION DEVICES,” filed Sep. 5, 2002 by Micklash II, et al., which is incorporated by reference.

To further illustrate, the systems of the invention are also optionally configured to dispense fluidic materials on substrate surfaces. For example, the systems described herein can be utilized to produce dot arrays or the like on substrate surfaces at various different densities. Arrayed materials are commonly used in, e.g., clinical testing (e.g., blood cholesterol tests, blood glucose tests, pregnancy tests, ovulation tests, etc.) in addition to many other applications known in the art. Essentially any substrate material is optionally adapted for use with the systems of the invention. In certain embodiments, for example, substrates are fabricated from silicon, glass, or polymeric materials (e.g., glass or polymeric microscope slides, silicon wafers, etc.). Suitable glass or polymeric substrates, including microscope slides, are available from various commercial suppliers, such as Fisher Scientific (Pittsburgh, Pa., USA) or the like. Optionally, substrates utilized in the systems of the invention are membranes. Suitable membrane materials are optionally selected from, e.g. polyaramide membranes, polycarbonate membranes, porous plastic matrix membranes (e.g., POREX® Porous Plastic, etc.), porous metal matrix membranes, polyethylene membranes, poly(vinylidene difluoride) membranes, polyamide membranes, nylon membranes, ceramic membranes, polyester membranes, polytetrafluoroethylene (TEFLON™) membranes, woven mesh membranes, microfiltration membranes, nanofiltration membranes, ultrafiltration membranes, dialysis membranes, composite membranes, hydrophilic membranes, hydrophobic membranes, polymer-based membranes, a non-polymer-based membranes, powdered activated carbon membranes, polypropylene membranes, glass fiber membranes, glass membranes, nitrocellulose membranes, cellulose membranes, cellulose nitrate membranes, cellulose acetate membranes, polysulfone membranes, polyethersulfone membranes, polyolefin membranes, or the like. Many of these membranous materials are widely available from various commercial suppliers, such as, P.J. Cobert Associates, Inc. (St. Louis, Mo., USA), Millipore Corporation (Bedford, Mass., USA), or the like.

H. Controllers, Computer Program Products, and Additional System Components

The controllers of the automated systems of the present invention are generally operably connected to and configured to control operation of pressure sources to effect dispensing of fluidic materials from the openings in conduits. In some embodiments, controllers are also operably connected to peristaltic pumps (e.g., via motor drives). Controllers are also typically operably connected to other system components, such as motors (e.g., via motor drives), positioning components (e.g., X/Y-axis linear motion tables, Z-axis motion components, etc.), cleaning components, detectors, fluid sensors, robotic translocation devices, or the like, to control operation of these components. More specifically, controllers are generally included either as separate or integral system components that are utilized, e.g., to effect fluidic material dispensing, the movement of positioning components, the detection and/or analysis of detectable signals received from sample containers by detectors, etc. Controllers and/or other system components is/are optionally coupled to an appropriately programmed processor, computer, digital device, or other logic device or information appliance (e.g., including an analog to digital or digital to analog converter as needed), which functions to instruct the operation of these instruments in accordance with preprogrammed or user input instructions (e.g., conduit cross-sectional dimensions, rotational increments, volumes to be conveyed, etc.), receive data and information from these instruments, and interpret, manipulate and report this information to the user.

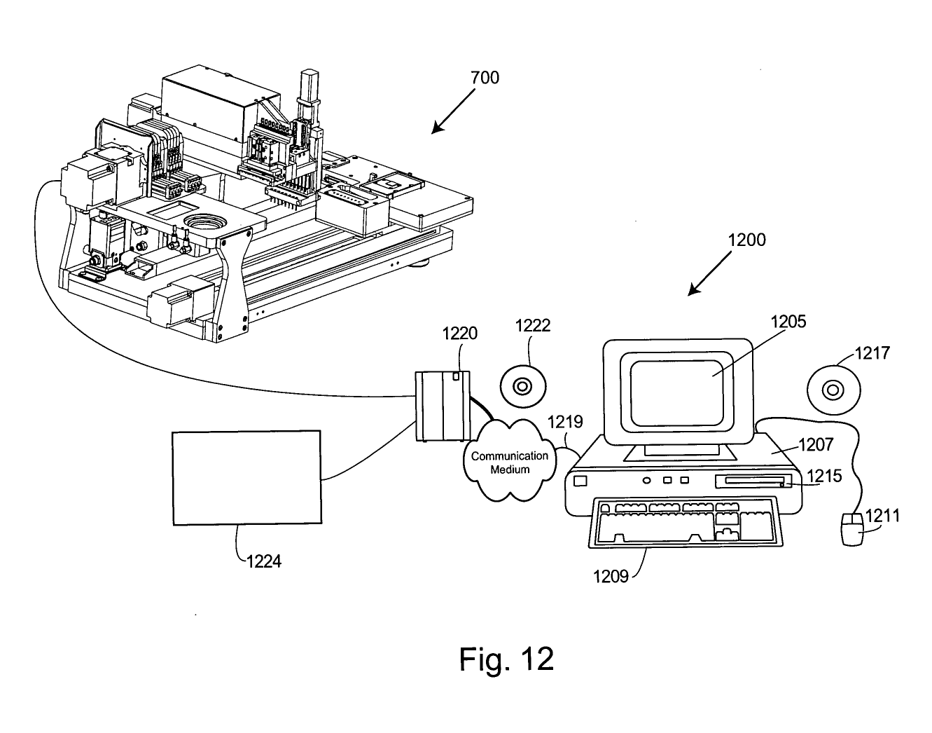

A controller or computer optionally includes a monitor which is often a cathode ray tube (“CRT”) display, a flat panel display (e.g., active matrix liquid crystal display, liquid crystal display, etc.), or others. Computer circuitry is often placed in a box, which includes numerous integrated circuit chips, such as a microprocessor, memory, interface circuits, and others. The box also optionally includes a hard disk drive, a floppy disk drive, a high capacity removable drive such as a writeable CD-ROM, and other common peripheral elements. Inputting devices such as a keyboard or mouse optionally provide for input from a user. An exemplary system comprising a computer is schematically illustrated in FIG. 12.

The computer typically includes appropriate software for receiving user instructions, either in the form of user input into a set of parameter fields, e.g., in a GUI, or in the form of preprogrammed instructions, e.g., preprogrammed for a variety of different specific operations. The software then converts these instructions to appropriate language for instructing the operation of one or more controllers to carry out the desired operation, e.g., varying or selecting the rate or mode of movement of positioning components, conveying fluidic materials through conduits with peristaltic pumps, opening valves to permit applied pressure from pressure sources to effect fluidic material dispensing, or the like. The computer then receives the data from, e.g., sensors/detectors included within the system, and interprets the data, either provides it in a user understood format, or uses that data to initiate further controller instructions, in accordance with the programming, e.g., such as in monitoring detectable signal intensity, multi-well container positioning, or the like.

More specifically, the software utilized to control the operation of the systems of the invention typically includes logic instructions that direct, e.g., the system to convey fluidic material to fluidic material sites, the pushers of an object holder of a positioning component to push containers into contact with alignment members when the containers are positioned on the object holder, a robotic handling device to translocate containers, and/or the like. To further illustrate, the invention provides control software, or computer program products that include computer readable media, having one or more logic instructions for operating at least one peristaltic pump to effect conveyance of at least a first fluidic material into at least one conduit through at least a first opening of the conduit, and operating at least one pressure source other than the peristaltic pump to effect application of pressure on the first fluidic material in the conduit such that at least one aliquot of the first fluidic material is dispensed from at least a second opening of the conduit. In certain embodiments, the computer program product includes at least one logic instruction for receiving one or more input parameters selected from the group consisting of: (i) a quantity of the first fluidic material to be conveyed to a fluidic material site; (ii) an initial density of the first fluidic material; (iii) a quantity of a second fluidic material to be added to the first fluidic material to modify a density of the first fluidic material; (iv) a quantity of gas to convey into the conduit to separate the first fluidic material from a second fluidic material; and (v) a fluidic material site format. In some embodiments, the computer program product includes at least one logic instruction for: operating at least one valve operably connected to the conduit to effect regulation of material conveyance into and/or out of the conduit. In certain embodiments, the computer program product includes at least one logic instruction for: operating at least one X/Y-axis linear motion component and/or at least one Z-axis motion component to effect movement of one or more other components attached to or positioned on the X/Y-axis linear motion component or the Z-axis motion component. The computer readable medium of, e.g., the computer program product optionally includes one or more of: a CD-ROM, a floppy disk, a tape, a flash memory device or component, a system memory device or component, a hard drive, a data signal embodied in a carrier wave, or the like.

The computer can be, e.g., a PC (Intel x86 or Pentium chip-compatible DOS™, OS2™, WINDOWS™, WINDOWS NT™, WINDOWS95™, WINDOWS98™, WINDOWS2000™, WINDOWS XP™, LINUX-based machine, a MACINTOSH™, Power PC, or a UNIX-based (e.g., SUN™ work station) machine) or other common commercially available computer which is known to one of skill. Standard desktop applications such as word processing software (e.g., Microsoft Word™ or Corel WordPerfect™) and database software (e.g., spreadsheet software such as Microsoft Excel™, Corel Quattro Pro™, or database programs such as Microsoft Access™ or Paradox™) can be adapted to the present invention. Software for performing, e.g., fluidic material dispensing into selected wells of a multi-well plate, assay detection, and data deconvolution is optionally constructed by one of skill using a standard programming language such as AppleScript, Visual basic, C, C++, Perl, Python, Fortran, Basic, Java, or the like.

The automated systems of the invention are optionally further configured to detect and quantify absorbance, transmission, and/or emission (e.g., luminescence, fluorescence, etc.) of light, and/or changes in those properties in samples that are arrayed in the wells of a multi-well container, on a substrate surface, or at other fluidic material sites. Alternatively, or simultaneously, detectors can quantify any of a variety of other signals from multi-well containers or other fluidic material sites including chemical signals (e.g., pH, ionic conditions, or the like), heat (e.g., for monitoring endothermic or exothermic reactions, e.g., using thermal sensors) or any other suitable physical phenomenon. In addition to other system components described herein, the material conveying systems of the invention optionally also include illumination or electromagnetic radiation sources, optical systems, and detectors. Because the systems and methods of the invention are flexible and allow essentially any chemistry to be assayed, they can be used for all phases of assay development, including prototyping and mass screening.

In some embodiments, the systems of the invention are configured for area imaging, but can also be configured for other formats including as a scanning imager or as a nonimaging counting system. An area imaging system typically places an entire multi-well container or other specimen onto the detector plane at one time. Accordingly, there is typically no need to move photomultiplier tubes (PMTs), to scan a laser, or the like, because the detector images the entire container onto many small detector elements (e.g., charge-coupled devices (CCDs), etc.) in parallel. This parallel acquisition phase is typically followed by a serial process of reading out the entire image from the detector. Scanning imagers typically pass a laser or other light beam over the specimen, to excite fluorescence, reflectance, or the like in a point-by-point or line-by-line fashion. In certain cases, confocal-optics are used to minimize out of focus fluorescence. The image is constructed over time by accumulating the points or lines in series. Nonimaging counting systems typically use PMTs or light sensing diodes to detect alterations in the transmission or emission of light, e.g., within wells of a multi-well container. These systems then typically integrate the light output from each well into a single data point.

A wide variety of illumination or electromagnetic sources and optical systems can be adapted for use in the systems of the present invention. Accordingly, no attempt is made herein to describe all of the possible variations that can be utilized in the systems of the invention and which will be apparent to one skilled in the art. Exemplary electromagnetic radiation sources that are optionally utilized in the systems of the invention include, e.g., lasers, laser diodes, electroluminescence devices, light-emitting diodes, incandescent lamps, arc lamps, flash lamps, fluorescent lamps, and the like. One preferred type of laser used in the assaying systems of the invention are argon-ion lasers. Exemplary optical systems that conduct electromagnetic radiation from electromagnetic radiation sources to sample containers and/or from multi-well containers to detectors typically include one or more lenses and/or mirrors to focus and/or direct the electromagnetic radiation as desired. Many optical systems also include fiber optic bundles, optical couplers, filters (e.g., filter wheels, etc.), and the like.

Suitable signal detectors that are optionally utilized in these systems detect, e.g., emission, luminescence, transmission, fluorescence, phosphorescence, absorbance, or the like. In some embodiments, the detector monitors a plurality of optical signals, which correspond in position to “real time” results. Example detectors or sensors include PMTs, CCDs, intensified CCDs, photodiodes, avalanche photodiodes, optical sensors, scanning detectors, or the like. Each of these as well as other types of sensors is optionally readily incorporated into the systems described herein. The detector optionally moves relative to fluidic material sites, such as multi-well plates or other assay components, or alternatively, multi-well plates or other assay components move relative to the detector. In certain embodiments, for example, detection components are coupled to translation components that move the detection components relative to fluidic material sites positioned on container positioning devices of the systems described herein. Optionally, the systems of the present invention include multiple detectors. In these systems, such detectors are typically placed either in or adjacent to, e.g., a multi-well plate or other vessel, such that the detector is in sensory communication with the multi-well plate or other vessel (i.e., the detector is capable of detecting the property of the plate or vessel or portion thereof, the contents of a portion of the plate or vessel, or the like, for which that detector is intended). In certain embodiments, detectors are configured to detect electromagnetic radiation originating in the wells of a multi-well container.

The detector optionally includes or is operably linked to a computer, e.g., which has system software for converting detector signal information into assay result information or the like. For example, detectors optionally exist as separate units, or are integrated with controllers into a single instrument. Integration of these functions into a single unit facilitates connection of these instruments with the computer, by permitting the use of a few or even a single communication port for transmitting information between system components. Detection components that are optionally included in the systems of the invention are described further in, e.g., Skoog et al., Principles of Instrumental Analysis, 5^{th} Ed., Harcourt Brace College Publishers (1998) and Currell, Analytical Instrumentation: Performance Characteristics and Quality, John Wiley & Sons, Inc. (2000), which are both incorporated by reference.

The systems of the invention optionally also include at least one robotic translocation or gripping component that is structured to grip and translocate fluidic material sites, such as multi-well plates between components of the automated systems and/or between the systems and other locations (e.g., other work stations, etc.). In certain embodiments, for example, systems further include gripping components that move multi-well plates between positioning components, incubation or storage components, etc. A variety of available robotic elements (robotic arms, movable platforms, etc.) can be used or modified for use with these systems, which robotic elements are typically operably connected to controllers that control their movement and other functions. Exemplary robotic gripping devices that are optionally adapted for use in the systems of the invention are described further in, e.g., U.S. Pat. No. 6,592,324, entitled “GRIPPER MECHANISM,” issued Jul. 15, 2003 to Downs et al., and International Publication No. WO 02/068157, entitled “GRIPPING MECHANISMS, APPARATUS, AND METHODS,” filed Feb. 26, 2002 by Downs et al., which are both incorporated by reference.

FIG. 12 is a schematic showing a representative example dispensing system including an information appliance in which various aspects of the present invention may be embodied. As will be understood by practitioners in the art from the teachings provided herein, the invention is optionally implemented in hardware and software. In some embodiments, different aspects of the invention are implemented in either client-side logic or server-side logic. As will also be understood in the art, the invention or components thereof may be embodied in a media program component (e.g., a fixed media component) containing logic instructions and/or data that, when loaded into an appropriately configured computing device, cause that apparatus or system to perform according to the invention. As will additionally be understood in the art, a fixed media containing logic instructions may be delivered to a viewer on a fixed media for physically loading into a viewer's computer or a fixed media containing logic instructions may reside on a remote server that a viewer accesses through a communication medium in order to download a program component.

FIG. 12 shows information appliance or digital device 1200 that may be understood as a logical apparatus (e.g., a computer, etc.) that can read instructions from media 1217 and/or network port 1219, which can optionally be connected to server 1220 having fixed media 1222. Information appliance 1200 can thereafter use those instructions to direct server or client logic, as understood in the art, to embody aspects of the invention. One type of logical apparatus that may embody the invention is a computer system as illustrated in 1200, containing CPU 1207, optional input devices 1209 and 1211, disk drives 1215 and optional monitor 1205. Fixed media 1217, or fixed media 1222 over port 1219, may be used to program such a system and may represent a disk-type optical or magnetic media, magnetic tape, solid state dynamic or static memory, or the like. In specific embodiments, the aspects of the invention may be embodied in whole or in part as software recorded on this fixed media. An exemplary computer program product is described further above. Communication port 1219 may also be used to initially receive instructions that are used to program such a system and may represent any type of communication connection. Optionally, aspects of the invention are embodied in whole or in part within the circuitry of an application specific integrated circuit (ACIS) or a programmable logic device (PLD). In such a case, aspects of the invention may be embodied in a computer understandable descriptor language, which may be used to create an ASIC, or PLD. FIG. 12 also includes dispensing system 700, which is operably connected to information appliance 1200 via server 1220. Optionally, dispensing system 700 is directly connected to information appliance 1200. During operation, dispensing system 700 typically conveys fluidic materials to selected fluidic material sites on a positioning component of dispensing system 700, e.g., as part of an assay or other process. FIG. 12 also shows detector 1224, which is optionally included in the systems of the invention. As shown, detector 1224 is operably connected to information appliance 1200 via server 1220. In some embodiments, detector 1224 is directly connected to information appliance 1200. In certain embodiments, detector 1224 is configured to detect detectable signals produced at fluidic material sites positioned on the positioning component of dispensing system 700. In other embodiments, fluidic material sites (e.g., multi-well containers, etc.) are transferred (e.g., manually or using a robotic translocation device) to detector 1224 before and/or after fluidic materials are dispensed at the fluidic material sites on the positioning component of dispensing system 700.

III. System Component Fabrication

System components (e.g., dispense heads, positioning components, cleaning components, etc.) are optionally formed by various fabrication techniques or combinations of such techniques including, e.g., machining, stamping, engraving, injection molding, cast molding, embossing, extrusion, etching (e.g., electrochemical etching, etc.), or other techniques. These and other suitable fabrication techniques are generally known in the art and described in, e.g., Altintas, Manufacturing Automation: Metal Cutting Mechanics, Machine Tool Vibrations, and CNC Design, Cambridge University Press (2000), Molinari et al. (Eds.), Metal Cutting and High Speed Machining, Kluwer Academic Publishers (2002), Stephenson et al., Metal Cutting Theory and Practice, Marcel Dekker (1997), Rosato, Injection Molding Handbook, 3^{rd} Ed., Kluwer Academic Publishers (2000), Fundamentals of Injection Molding, W. J. T. Associates (2000), Whelan, Injection Molding of Thermoplastics Materials, Vol. 2, Chapman & Hall (1991), Fisher, Extrusion of Plastics, Halsted Press (1976), and Chung, Extrusion of Polymers: Theory and Practice, Hanser-Gardner Publications (2000), which are each incorporated by reference. In certain embodiments, following fabrication, system components are optionally further processed, e.g., by coating surfaces with a hydrophilic coating, a hydrophobic coating (e.g., a Xylan 1010DF/870 Black coating available from Whitford Corporation (West Chester, Pa.), etc.), or the like, e.g., to prevent interactions between component surfaces and reagents, samples, or the like.

IV. Dispensing Methods

In addition to the systems and computer program products described herein, the invention also relates to methods of dispensing fluidic materials. To illustrate, certain methods relate to dispensing aliquots of fluidic materials that have substantially uniform densities. As referred to herein, density variations among dispensed fluidic materials can negatively impact dispensing applications in various ways including leading to biased assay results and to inconsistent synthetic yields. To minimize these density variations, some of these methods include conveying selected aliquots of fluidic materials from dispensing tips that fluidly communicate with conduits that include non-vertical flow paths. These non-vertical flow paths prevent components (e.g., beads, cells, etc.) in the fluidic materials from settling proximal to the dispensing tips prior to being dispensed. In this manner, subsequently dispensed aliquots generally have substantially the same densities as previously dispensed aliquots for a given dispensed fluidic material.

In some embodiments, the dispensing methods of the invention include conveying a first fluidic material (e.g., a source fluid, such as a solution comprising beads, cells, enzymes, reagents, and/or the like) into a conduit through a first opening of the conduit using a peristaltic pump. These methods also include applying pressure on the first fluidic material in the conduit using another pressure source such that selected aliquots of the first fluidic material are dispensed from a second opening of the conduit at material sites, such as into the wells of multi-well containers, onto substrate surfaces, etc., e.g., as part of synthesis reactions, screens, assays, or the like. This process is typically repeated as desired. Peristaltic pumps and other pressure sources are described further above.

In addition, these dispensing methods optionally include conveying a second fluidic material (e.g., a system fluid, such as a buffer, etc.) through one or more segments of the conduit using the pressure source such that the second fluidic material expels the aliquots of the first fluidic material from the second opening of the conduit. In some of these embodiments, the methods include diluting the first fluidic material with the second fluidic material prior to or substantially simultaneously with expelling the aliquots of the first fluidic material from the second opening of the conduit. Further, the methods optionally include conveying a gas into the conduit through a port to form a gap between the first and second fluidic materials to prevent the first and second fluidic materials from mixing with one another. Moreover, the methods optionally include conveying a gas into the conduit to purge fluidic materials from at least one segment of the conduit prior to conveying the first fluidic material into the conduit.

In certain embodiments, fluidic material conveyance is restricted in the conduit directed towards the peristaltic pump during the application of pressure by the pressure source, e.g., to prevent fluidic materials from flowing towards the peristaltic pump and the fluidic material source. In some embodiments, these methods include moveably positioning fluidic material sites and the second opening of the conduit relative to one another, e.g., using a positioning component described herein. The moving and conveying steps are typically performed substantially simultaneous with one another, e.g., to effect “on-the-fly” fluidic material dispensing. Furthermore, the methods optionally include detecting detectable signals produced in the conduit and/or in the aliquots of the first fluidic material dispensed from the conduit.

To further illustrate an exemplary embodiment, some methods of dispensing fluidic materials include the use of dispensing systems having fluid junction blocks, such as those schematically shown in FIGS. 5 A and B, which are also described above. Fluid junction blocks are typically utilized to inject small, precise, and repeatable gaseous gaps into these systems to separate system and source fluids from one another, such that system fluids do not dilute the source fluids in these embodiments. These fluid junction blocks typically include at least a portion of a first conduit (e.g., first conduit 504) that fluidly communicates with a first fluidic material source (e.g., first fluidic material source 506). Fluid junction blocks also typically include at least a portion of a second conduit (e.g., fluid junction block conduit 532), which has at least first and second openings (e.g., first opening 531 and second opening 533) and at least one port (e.g., port 530) disposed through a wall of the second conduit. The port communicates with a cavity disposed through the second conduit. In addition, the first conduit generally intersects and fluidly communicates with the second conduit between the port and the second opening of the second conduit.

These methods of dispensing fluidic materials also include conveying a volume of a second fluidic material (e.g., a system fluid, etc.) through the first opening of the second conduit proximal to the port. During this step, the port is typically closed and a valve (e.g., valve 520) is generally opened long enough ensure that no air (e.g., ˜100% system fluid) is disposed between the source of the second fluidic material (e.g., pressure source 518) and the port. A pinch valve of the system (e.g., pinch valve 510) is opened or closed during this step. These methods also generally include restricting fluidic material conveyance through the first opening of the second conduit and through the first conduit. During this step, the valve (e.g., valve 520) is typically closed to restrict fluidic material conveyance through the first opening of the second conduit. The pinch valve can be opened or closed during this step, since the peristaltic pump acts as a valve to prevent fluidic material flow into the first fluidic material source. These methods also include conveying gas (e.g., air, nitrogen, argon, etc. at between about 5-10 psi) into the second conduit through the port to purge fluidic materials, if any, from the second conduit downstream from the port through the second opening of the second conduit.

In addition, these methods also include restricting fluidic material conveyance through the first opening of the second conduit (e.g., using valve 520) and gas conveyance through the port (e.g., using gas valve 534). In certain embodiments, the pinch valve is opened and the peristaltic pump is turned on in reverse so that source fluid that may be in, e.g., the first or another conduit is conveyed back into the first fluidic material source. Then, with the flow through the first opening of the second conduit and port restricted, the methods typically include conveying a volume of a first fluidic material (e.g., a source fluid, etc.) from the first fluidic material source through the first conduit and into the second conduit proximal to and downstream from the intersection of the first and second conduits such that a volume of the gas is disposed between the first and second fluidic materials in the second conduit. Furthermore, the methods also typically include restricting fluidic material conveyance through the first conduit, e.g., by closing the pinch valve and restricting gas conveyance through the port, e.g., by closing the port, and applying pressure to the second fluidic material (e.g., using pressure source 518 with valve 520 open) in the second conduit such that at least one selected aliquot of the first fluidic material is dispensed from the second opening of the second conduit or another conduit that fluidly communicates with the second conduit (e.g., third conduit 524). One or more of these steps is optionally repeated.

Although other fluidic material volumes may be conveyed using the systems and methods described herein, dispensed volumes or aliquots generally include at least about 0.1 μL of fluidic material. Microliter volumes are generally desirable, e.g., when conveying fluidic materials to and/or from high-density multi-well plates, such as 1536-well plates having total volume capacities that are typically between about 10 to about 15 μL/well, with the systems of the present invention. Larger volumes of fluidic material (e.g., milliliter volumes, liter volumes, etc.) are also optionally conveyed using the systems of the present invention.

Essentially any biochemical or cellular assay, or synthesis reaction, can be adapted for performance in the systems and according to the methods of the invention. To illustrate, common types of assays performed in, e.g., multi-well plates include those relating to signal transduction, cell adhesion, apoptosis, cell migration, GPCR, cell permeability, receptor/ligand binding, intracellular calcium flux, membrane potential, nucleic acid hybridization, cell growth/proliferation, among many others that are known in the art. Additional details relating to certain of these and other assays involving multi-well plates are described in, e.g., Parker et al. (2000) “Development of high throughput screening assays using fluorescence polarization: nuclear receptor-ligand binding and kinase/phosphatase assays,” J. Biomolecular Screening 5(2):77-88, Asa (2001) “Automating cell permeability assays,” Screening 1:36-37, Norrington (1999) “Automation of the drug discovery process,” Innovations in Pharmaceutical Technology 1(2):34-39, Fukushima et al. (2001) “Induction of reduced endothelial permeability to horseradish peroxidase by factor(s) of human astrocytes and bladder carcinoma cells: detection in multi-well plate culture,” Methods Cell Sci. 23(4):211-9, Neumayer (1998) “Fluorescence ELISA, a comparison between two fluorogenic and one chromogenic enzyme substrate,” BPI 10(Nr. 5), Graeff et al. (2002) “A novel cycling assay for nicotinic acid-adenine dinucleotide phosphate with nanomolar sensitivity,” Biochem J. 367(Pt 1):163-8, Rogers et al. (2002) “Fluorescence detection of plant extracts that affect neuronal voltage-gated Ca²⁺ channels,” Eur. J. Pharm. Sci. 15(4):321-30, and Rappaport et al. (2002) “New perfluorocarbon system for multilayer growth of anchorage-dependent mammalian cells,” Biotechniques 32(1):142-51, which are each incorporated by reference.

While the foregoing invention has been described in some detail for purposes of clarity and understanding, it will be clear to one skilled in the art from a reading of this disclosure that various changes in form and detail can be made without departing from the true scope of the invention. For example, all the techniques and apparatus described above can be used in various combinations. All publications, patents, patent applications, and/or other documents cited in this application are incorporated by reference in their entirety for all purposes to the same extent as if each individual publication, patent, patent application, and/or other document were individually indicated to be incorporated by reference for all purposes.

What is claimed is:

1. A dispensing system, comprising:
at least one peristaltic pump configured to convey at least a first fluidic material into or through at least a portion of at least one conduit when the conduit is operably connected to the peristaltic pump and is in fluid communication with at least a first fluidic material source;
at least one pressure source other than the peristaltic pump, which pressure source is configured to apply pressure in the conduit when the pressure source is operably connected to the conduit such that selected aliquots of the first fluidic material are dispensed from at least one opening in the conduit when the first fluidic material is present in the conduit; and,
at least one controller operably connected to the pressure source, which controller is configured to control operation of the pressure source to effect dispensing of the first fluidic material from the opening in the conduit when the conduit is in fluid communication with the first fluidic material source.

2. The dispensing system of claim 1, wherein the peristaltic pump comprises a multi-channel peristaltic pump.

3. The dispensing system of claim 1, wherein the controller is operably connected to the peristaltic pump and configured to effect rotation of a roller support of the peristaltic pump in at least one rotational increment that substantially corresponds to an integral multiple of an angular distance disposed between adjacent rollers supported by the roller support such that quantities of the first fluidic material that correspond to the rotational increment are conveyed into or through the conduit when the conduit is operably connected to the peristaltic pump and is in fluid communication with the first fluidic material source.

4. The dispensing system of claim 1, comprising a mounting component to which the peristaltic pump, the pressure source, the controller, and/or another system component is attached.

5. The dispensing system of claim 1, wherein the dispensing system comprises the conduit.

6. The dispensing system of claim 5, comprising at least one waste collection component configured to selectively communicate with the opening in the conduit.

7. The dispensing system of claim 5, comprising a fluid reservoir in fluid communication with the conduit.

8. The dispensing system of claim 5, wherein a substantial portion of the conduit is disposed other than parallel to a Z-axis of the dispensing system.

9. The dispensing system of claim 5, wherein at least a segment of the conduit that comprises the opening is disposed at an angle of between about 0° and about 90° relative to a Z-axis of the dispensing system.

10. The dispensing system of claim 5, wherein the opening in the conduit comprises at least one dispensing tip.

11. The dispensing system of claim 5, wherein the opening in the conduit comprises at least one manifold that is configured to fluidly communicate with multiple fluidic material sites.

12. The dispensing system of claim 5, wherein the pressure source comprises one or more pumps.

13. The dispensing system of claim 5, wherein the dispensing system comprises multiple conduits.

14. The dispensing system of claim 13, wherein openings in at least two of the conduits are spaced at a distance from one another to simultaneously fluidly communicate with different wells disposed in at least one multi-well container.

15. The dispensing system of claim 5, wherein at least a segment of the conduit disposed between the opening and the peristaltic pump comprises a conduit coil.

16. The dispensing system of claim 15, wherein at least one coil in the conduit coil is disposed other than parallel to a Z-axis of the dispensing system.

17. The dispensing system of claim 5, wherein the peristaltic pump is operably connected to at least a first conduit and the pressure source is operably connected to at least a second conduit, which first and second conduits fluidly communicate with one another.

18. The dispensing system of claim 17, wherein at least one three-way valve is operably connected to the first conduit, which three-way valve is structured to selectively vent the first conduit.

19. The dispensing system of claim 5, wherein the pressure source is in fluid communication with the conduit.

20. The dispensing system of claim 19, comprising at least one filter operably connected to the conduit.

21. The dispensing system of claim 19, wherein the pressure source comprises a pressurized gas source and/or a pressurized second fluidic material source.

22. The dispensing system of claim 21, wherein the second fluidic material source comprises at least one buffer.

23. The dispensing system of claim 5, wherein the pressure source is operably connected to the conduit via at least one solenoid valve that regulates pressure applied by the pressure source.

24. The dispensing system of claim 23, wherein the controller is operably connected to the solenoid valve, which controller is configured to control operation of the solenoid valve to effect regulation of the applied pressure.

25. The dispensing system of claim 5, wherein at least one port is disposed through at least one wall of the conduit, which port communicates with at least one cavity disposed through the conduit.

26. The dispensing system of claim 25, wherein the port comprises a length of about 5 mm or less.

27. The dispensing system of claim 25, wherein a region of the conduit that comprises the port comprises a fluid junction block.

28. The dispensing system of claim 25, wherein the port is disposed between the peristaltic pump and the pressure source in the conduit.

29. The dispensing system of claim 25, wherein at least one gas valve is operably connected to the port, which gas valve regulates gas flow into the conduit through the port when the gas valve is operably connected to at least one pressurized gas source.

30. The dispensing system of claim 29, wherein the gas valve comprises a plunger comprising a compliant seal material that forms a face seal with the port when the plunger pushes the compliant seal material into contact with the port.

31. The dispensing system of claim 29, wherein the gas valve is operably connected to the pressurized gas source, which pressurized gas source flows gas to the gas valve at a pressure of between about zero pounds per square inch and about 10 pounds per square inch.

32. The dispensing system of claim 31, wherein the gas comprises air, nitrogen, helium, or argon.

33. The dispensing system of claim 29, wherein at least one air table is operably connected to the gas valve, which air table is configured to effect operation of the gas valve.

34. The dispensing system of claim 33, wherein the controller is operably connected to the air table, which controller is configured to control operation of the air table to effect regulation of gas flow into the conduit through the port when the gas valve is operably connected to the pressurized gas source.

35. The dispensing system of claim 1, comprising at least one pinch valve configured to regulate conveyance of fluidic materials through the conduit when the conduit is operably connected to the pinch valve.

36. The dispensing system of claim 35, wherein at least one air table is operably connected to the pinch valve, which air table is configured to effect operation of the pinch valve.

37. The dispensing system of claim 36, wherein the controller is operably connected to the air table, which controller is configured to control operation of the air table to effect regulation of fluidic material conveyance through the conduit when the conduit is operably connected to the pinch valve.

38. The dispensing system of claim 1, wherein the dispensing system comprises the first fluidic material source.

39. The dispensing system of claim 38, wherein the first fluidic source comprises one or more of: beads, cells, enzymes, or reagents.

40. The dispensing system of claim 38, wherein at least one fluid agitation mechanism is operably connected to the first fluidic material source.

41. The dispensing system of claim 1, comprising at least one positioning component operably connected to the controller, which positioning component is configured to moveably position one or more conduits and/or one or more fluidic material sites relative to one another.

42. The dispensing system of claim 41, wherein the positioning component comprises at least one X/Y-axis linear motion component operably connected to at least one control drive that controls movement of the X/Y-axis linear motion component along an X-axis and a Y-axis of the dispensing system.

43. The dispensing system of claim 41, wherein the controller is operably connected to the pressure source and is configured to simultaneously effect application of pressure in the conduits from the pressure source and moveably position the conduits and/or the fluidic material sites relative to one another such that volumes of fluid are conveyed from the conduits synchronous with the relative movement of the conduits and/or the fluidic material sites.

44. The dispensing system of claim 41, wherein the positioning component comprises at least one Z-axis linear motion component comprising at least one conduit support head that is configured to support at least segments of the conduits and that moves along a Z-axis of the dispensing system.

45. The dispensing system of claim 41, wherein the positioning component comprises at least one object holder that is structured to support at least one fluidic material site.

46. The dispensing system of claim 41, comprising at least one cleaning component operably connected to the controller, which cleaning component is configured to clean at least segments of the conduits when the conduits are operably connected to the positioning component and the positioning component moves the conduit segments at least proximal to the cleaning component.

47. The dispensing system of claim 46, wherein the cleaning component comprises at least one vacuum chamber comprising at least one orifice into or proximal to which the positioning component moves the conduit segments such that an applied vacuum removes adherent material from at least external surfaces of the conduit segments.

48. The dispensing system of claim 1, comprising at least one detector configured to detect detectable signals produced in fluidic materials.

49. The dispensing system of claim 48, wherein the controller is operably connected to the detector, which controller is configured to control the detector to effect detection of the detectable signals.

50. A computer program product comprising a computer readable medium having one or more logic instructions for:
operating at least one peristaltic pump to effect conveyance of at least a first fluidic material into at least one conduit through at least a first opening of the conduit; and,
operating at least one pressure source other than the peristaltic pump to effect application of pressure on the first fluidic material in the conduit such that at least one aliquot of the first fluidic material is dispensed from at least a second opening of the conduit.

51. The computer program product of claim 50, comprising at least one logic instruction for:
receiving one or more input parameters selected from the group consisting of:
(i) a quantity of the first fluidic material to be conveyed to a fluidic material site;
(ii) an initial density of the first fluidic material;
(iii) a quantity of a second fluidic material to be added to the first fluidic material to modify a density of the first fluidic material;
(iv) a quantity of gas to convey into the conduit to separate the first fluidic material from a second fluidic material; and
(v) a fluidic material site format.

52. The computer program product of claim 50, comprising at least one logic instruction for:
operating at least one valve operably connected to the conduit to effect regulation of material conveyance into and/or out of the conduit.

53. The computer program product of claim 50, comprising at least one logic instruction for:
operating at least one X/Y-axis linear motion component and/or at least one Z-axis motion component to effect movement of one or more other components attached to or positioned on the X/Y-axis linear motion component or the Z-axis motion component.

54. A method of dispensing a fluidic material, the method comprising:
(a) conveying at least a first fluidic material into at least one conduit through at least a first opening of the conduit using at least one peristaltic pump; and,
(b) applying pressure on the first fluidic material in the conduit using at least one pressure source other than the peristaltic pump such that at least one aliquot of the first fluidic material is dispensed from at least a second opening of the conduit.

55. The method of claim 54, comprising dispensing the aliquot of the first fluidic material unto a wall of a container.

56. The method of claim 54, comprising dispensing multiple aliquots of the first fluidic material during (b).

57. The method of claim 54, comprising repeating (a) and (b).

58. The method of claim 54, comprising restricting fluidic material conveyance in the conduit directed towards the peristaltic pump during (b).

59. The method of claim 54, comprising conveying a gas into the conduit to purge fluidic materials from at least one segment of the conduit prior to (a).

60. The method of claim 54, comprising moveably positioning at least one fluidic material site relative to the second opening.

61. The method of claim 54, comprising detecting one or more detectable signals produced in the conduit and/or in the aliquot of the first fluidic material.

62. The method of claim 54, comprising performing at least one synthesis reaction or assay using one or more components in the aliquot of the first fluidic material after (b).

63. The method of claim 54, comprising performing (a) and (b) substantially simultaneously with one another.

64. The method of claim 54, wherein the first fluidic material comprises one or more of: beads, cells, enzymes, or reagents.

65. The method of claim 54, wherein at least a segment of the conduit comprises a non-vertical flow path to prevent one or more components of the first fluidic material from settling proximal to the second opening.

66. The method of claim 54, comprising conveying at least a second fluidic material through one or more segments of the conduit using the pressure source such that the second fluidic material expels the aliquot of the first fluidic material from the second opening of the conduit during (b).

67. The method of claim 66, wherein the second fluidic material comprises a buffer.

68. The method of claim 66, comprising diluting the first fluidic material with the second fluidic material prior to or substantially simultaneously with (b).

69. The method of claim 66, comprising conveying a gas into the conduit through a port to form a gap between the first and second fluidic materials to prevent the first and second fluidic materials from mixing with one another.

70. A method of dispensing aliquots of fluidic materials having substantially uniform densities, the method comprising conveying selected aliquots of at least one fluidic material from at least one dispensing tip that fluidly communicates with at least one conduit through which the fluidic material is conveyed, which conduit comprises a non-vertical flow path such that components in the fluidic material are prevented from settling proximal to the dispensing tip prior to being dispensed, thereby dispensing the aliquots of fluidic materials having substantially uniform densities.

71. A method of dispensing a fluidic material, the method comprising:
(a) providing a dispensing system having a fluid junction block comprising:
(i) at least a portion of a first conduit that fluidly communicates with a first fluidic material source;
(ii) at least a portion of a second conduit having:
(I) at least first and second openings; and
(II) at least one port disposed through a wall of the second conduit, which port communicates with a cavity disposed through the second conduit,
wherein the first conduit intersects and fluidly communicates with the second conduit between the port and the second opening of the second conduit;
(b) conveying a volume of a second fluidic material through the first opening of the second conduit proximal to the port;
(c) restricting fluidic material conveyance through the first opening of the second conduit and through the first conduit;
(d) conveying at least one gas into the second conduit through the port to purge fluidic materials from the second conduit downstream from the port through the second opening of the second conduit;
(e) restricting fluidic material conveyance through the first opening of the second conduit and gas conveyance through the port;
(f) conveying a volume of a first fluidic material from the first fluidic material source through the first conduit and into the second conduit proximal to and downstream from the intersection of the first and second conduits such that a volume of the gas is disposed between the first and second fluidic materials in the second conduit;
(g) restricting fluidic material conveyance through the first conduit and gas conveyance through the port; and,
(h) applying pressure to the second fluidic material in the second conduit such that at least one selected aliquot of the first fluidic material is dispensed from the second opening of the second conduit.
